(19) United States
(12) Patent Application Publication
(10) Pub. No.: US 2018/0049205 A1
(43) Pub. Date: Feb. 15, 2018

(54) COMMUNICATIONS SYSTEM, COMMUNICATIONS CONTROL APPARATUS, RADIO COMMUNICATIONS APPARATUS, AND COMMUNICATIONS METHOD

(71) Applicant: FUJITSU LIMITED, Kawasaki-shi (JP)

(72) Inventor: Teppei OYAMA, Kawasaki (JP)

(73) Assignee: FUJITSU LIMITED, Kawasaki-shi (JP)

(21) Appl. No.: 15/794,499

(22) Filed: Oct. 26, 2017

Related U.S. Application Data
(63) Continuation of application No. 14/741,887, filed on Jun. 17, 2015.
Application No. 14/741,887 is a continuation of application No. PCT/JP2012/083394, filed on Dec. 25, 2012.

(51) Int. Cl. H04W 72/04; H04W 64/00

(52) U.S. Cl. CPC H04W 72/0453; H04W 72/048; H04W 64/00

(57) ABSTRACT

A radio communications apparatus transmits to a communications control apparatus, route information indicating a position and a predicted route of the radio communications apparatus. For each frequency available to the radio communications apparatus at the position of the radio communications apparatus, the communications control apparatus calculates a predicted time for the frequency to become unavailable to the radio communications apparatus, based on the route information and correspondence information of the position of the radio communications apparatus and the frequencies available to the radio communications apparatus; selects a frequency from among the frequencies available to the radio communications apparatus at the position of the radio communications apparatus, based on the calculated predicted time; and transmits to the radio communications apparatus, frequency information indicating the selected frequency. The radio communications apparatus performs radio communication using the frequency indicated by the frequency information transmitted from the communications control apparatus.

### CROSS REFERENCE TO RELATED APPLICATIONS

This application is a continuation of U.S. application Ser. No. 14/741,887, filed on Jun. 17, 2015, which is a continuation application of International Application PCT/JP2012/083394, filed on Dec. 25, 2012 and designating the U.S., the entire contents of which are incorporated herein by reference.

### FIELD

The embodiments discussed herein are related to a communications system, a communications control apparatus, a radio communications apparatus, and a communications method.

### BACKGROUND

Radio traffic continues to increase rapidly and demand for limited frequency resources continues to increase. As one means of achieving effective use of frequency, cognitive radio technology, which is cognizant of the local radio wave environment and optimizes communication, is being studied. For example, whitespace type (or frequency shared type) cognitive radio has a function that finds frequency whitespace (WS), which is dependent on time and location, to perform communication so as not to interfere with systems allowed preferential use of frequency. Use of TV whitespace (TVWS) for communications is under investigation in US, for example.

With whitespace type cognitive radio, for example, a system having priority to use a frequency is called a primary system, while a system finding a whitespace for communication is called a secondary system. In the case of TVWS, systems for TV broadcasting are primary systems.

Wide frequency bandwidths in the ultra-high frequency (UHF) spectrum, etc. are assigned for the TV broadcasting. The frequencies (physical TV channels) used differ from place to place and have little temporal variation. Methods of finding such quasi-static TVWS include, for example, a sensing scheme and a database accessing scheme. For example, rules announced by the federal communications commission (FCC) prescribe a sensing scheme and a database accessing scheme.

In the database accessing scheme, a secondary system, for example, accesses a database on the network to obtain WS information indicative of whitespace. The database stores WS information correlated with position information, the WS information being calculated from information such as the location of TV transmitting stations, transmission power, and transmission frequency. FCC rules prescribe that when using TVWS, a secondary system employing a database accessing scheme should access the database at least once a day.

According to a known technique (see, for example, Japanese Laid-Open Patent Publication No. 2012-54799), a detection frequency channel is detected based on radio waves transmitted from a first existing system, a reception frequency channel is received from a nearby device, and based on the detection frequency channel, the reception frequency channel, and list frequency channels indicated by a frequency list, a new frequency list indicating the frequency channels is created and stored.

Nonetheless, with the conventional technique above, frequency switching may increase since the available frequency changes with the movement of the radio communications device.

### SUMMARY

According to an aspect of an embodiment, a communications system includes a radio communications apparatus and a communications control apparatus. The radio communications apparatus includes a radio communications interface configured to transmit to the communications control apparatus, route information indicating a position of the radio communications apparatus and a predicted route of the radio communications apparatus. The communications control apparatus includes a processor configured to calculate for each frequency available to the radio communications apparatus at the position of the radio communications apparatus, any one among a predicted time and a predicted movement distance for the frequency to become unavailable to the radio communications apparatus, based on the route information transmitted from the radio communications apparatus and, correspondence information of positions of the radio communications apparatus and frequencies available to the radio communications apparatus. The processor is further configured to select a frequency to be used by the radio communications apparatus among the frequencies available to the radio communications apparatus at the position of the radio communications apparatus, based on any one among the predicted time and the predicted movement distance calculated by the processor. The communications control apparatus further includes a radio communications interface configured to transmit to the radio communications apparatus, frequency information indicating the frequency selected by the processor. The radio communications interface of the radio communications apparatus is further configured to perform radio communication using the frequency indicated by the frequency information transmitted from the communications control apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram of an example of a communications system according to a first embodiment;

FIG. 1B is a diagram of an example of signal flow in the communications system depicted in FIG. 1A;

FIG. 2 is a diagram of a first application example of the communications system according to the first embodiment;

FIG. 3A is a diagram of an example of configuration of the communications system depicted in FIG. 2;

FIG. 3B is a diagram of an example of signal flow in the communications system depicted in FIG. 3A;

FIG. 3C is a diagram of an example of hardware configuration of an access point;

FIG. 3D is a diagram of an example of hardware configuration of a WS database server;

FIG. 4 is a sequence diagram of an operation example of the communications system depicted in FIG. 2;

FIG. 5 is a diagram of an example of predicted route information transmitted by the access point;

FIG. 6 is a diagram of an example of correspondence information stored in a WS database;

FIG. 7 is a diagram of an example of frequencies available at positions on the predicted route depicted in FIG. 2;

FIG. 8 is a diagram of a second application example of the communications system according to the first embodiment;

FIG. 9A is a diagram of an example of configuration of the communications system depicted in FIG. 8;

FIG. 9B is a diagram of an example of signal flow in the communications system depicted in FIG. 9A;

FIG. 10 is a diagram of a third application example of the communications system according to the first embodiment;

FIG. 11 is a diagram of an example of frequencies available at positions on a predicted route depicted in FIG. 10;

FIG. 12A is a diagram of an example of the communications system according to a second embodiment;

FIG. 12B is a diagram of an example of signal flow in the communications system depicted in FIG. 12A;

FIG. 13 is a diagram of an application example of the communications system according to the second embodiment;

FIG. 14A is a diagram of an example of configuration of the communications system depicted in FIG. 13;

FIG. 14B is a diagram of an example of signal flow in the communications system depicted in FIG. 14A;

FIG. 15 is a sequence diagram of an operation example of the communications system depicted in FIG. 13;

FIG. 16 is a diagram of an example of available frequency information;

FIG. 17 is a diagram of an example of switching history information;

FIG. 18 is a diagram of an example of frequency switching history on the predicted route depicted in FIG. 13;

FIG. 19 is a diagram of another example of the switching history information;

FIG. 20 is a diagram of an application example of the communications system according to a third embodiment;

FIG. 21 is a sequence diagram of an operation example of the communications system depicted in FIG. 20;

FIG. 22 is a diagram of an example of frequencies available at positions on a predicted route depicted in FIG. 20;

FIG. 23 is a diagram of an application example of the communications system according to a fourth embodiment;

FIG. 24A is a diagram of an example of configuration of the communications system depicted in FIG. 13;

FIG. 24B is a diagram of an example of signal flow in the communications system depicted in FIG. 24A;

FIG. 25 is a sequence diagram of an operation example of the communications system depicted in FIG. 23;

FIG. 26 is a diagram of an example of the distance between a history position and a current position;

FIG. 27 is a diagram of another example of a predetermined range;

FIG. 28A is a diagram of an example of the communications system according to a fifth embodiment;

FIG. 28B is a diagram of an example of signal flow in the communications system depicted in FIG. 28A;

FIG. 28C is a diagram of another example of signal flow in the communications system depicted in FIG. 28A;

FIG. 29 is a diagram of an application example of the communications system according to the fifth embodiment;

FIG. 30A is a diagram of an example of configuration of the communications system depicted in FIG. 29;

FIG. 30B is a diagram of an example of signal flow in the configuration of the communications system depicted in FIG. 30A;

FIG. 31 is a sequence diagram of an operation example of the communications system depicted in FIG. 29;

FIG. 32 is a diagram of an example of switching information;

FIG. 33 is a diagram of an application example of the communications system according to a sixth embodiment;

FIG. 34 is a diagram of an example of frequencies available at positions on a predicted route depicted in FIG. 33;

FIG. 35 is a diagram of an example of an updated table indicating available frequencies; and

FIG. 36 is a diagram of another example of the updated table indicating available frequencies.

### DESCRIPTION OF EMBODIMENTS

Embodiments of a communications system, a communications control apparatus, a radio communications apparatus, and a communications method will be described in detail with reference to the accompanying drawings.

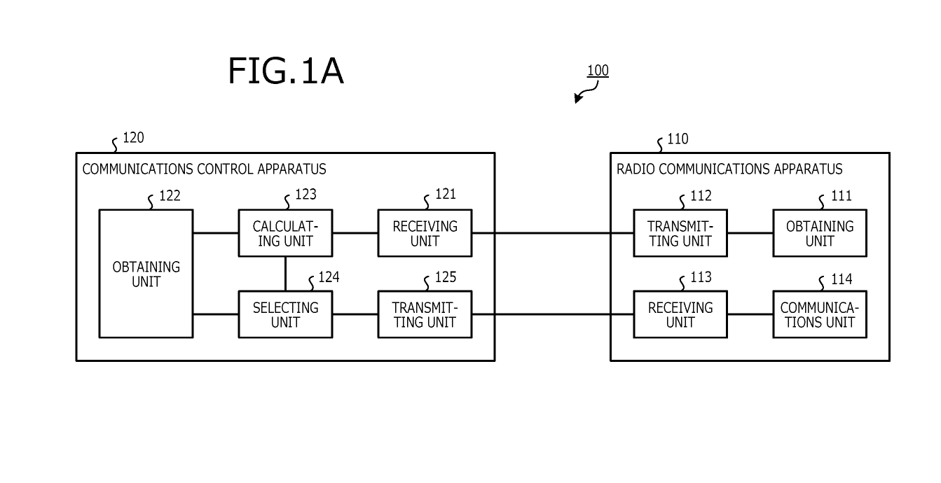

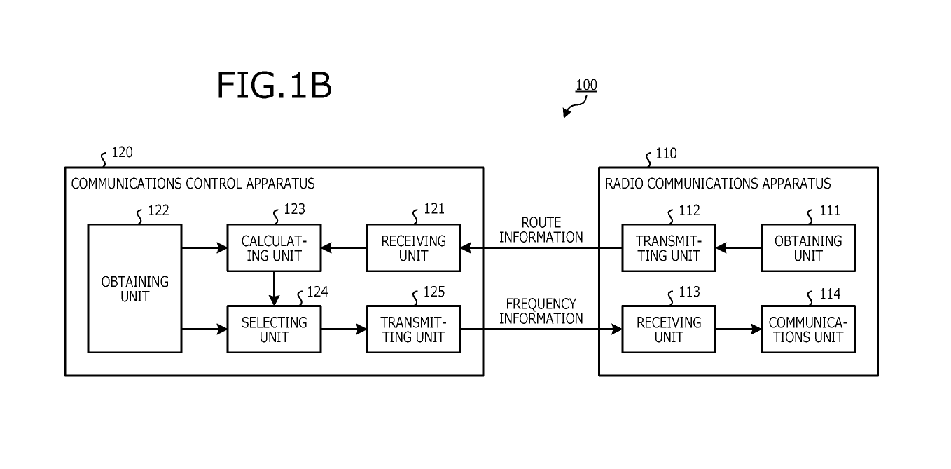

FIG. 1A is a diagram of an example of a communications system according to a first embodiment. FIG. 1B is a diagram of an example of signal flow in the communications system depicted in FIG. 1A. As depicted in FIGS. 1A and 1B, a communications system 100 according to the first embodiment includes a radio communications apparatus 110 and a communications control apparatus 120. The radio communications apparatus 110 and the communications control apparatus 120 can communicate with each other. Various schemes of communication can be applied for the communication between the radio communications apparatus 110 and the communications control apparatus 120.

The radio communications apparatus 110 includes an obtaining unit 111, a transmitting unit 112, a receiving unit 113, and a communications unit 114. The obtaining unit 111 obtains route information indicating a position of the radio communications apparatus 110 (the apparatus itself) and a predicted route of the radio communications apparatus 110 in the future. The position of the radio communications apparatus 110 is, for example, an approximate position of the radio communications apparatus 110 at present. The obtaining unit 111 outputs the obtained route information to the transmitting unit 112. The transmitting unit 112 transmits to the communications control apparatus 120 (a radio communications apparatus), the route information output from the obtaining unit 111.

The receiving unit 113 receives frequency information transmitted from the communications control apparatus 120. The receiving unit 113 outputs the received frequency information to the communications unit 114. The communications unit 114 performs radio communication using a frequency indicated by the frequency information output from the receiving unit 113. For example, the communications unit 114 performs communication with a base station connected to a mobile communication network.

The communications control apparatus 120 includes a receiving unit 121, an obtaining unit 122, a calculating unit 123, a selecting unit 124, and a transmitting unit 125. The receiving unit 121 receives route information transmitted from the radio communications apparatus 110. The receiving unit 121 outputs the received route information to the calculating unit 123.

The obtaining unit 122 obtains correspondence information for the position of the radio communications apparatus 110 and the frequencies available to the radio communications apparatus 110. For example, the correspondence information is stored in the memory of the communications control apparatus 120, and the obtaining unit 122 obtains the correspondence information from the memory of the communications control apparatus 120. The obtaining unit 122 may receive the correspondence information from a communication apparatus external to the communications control apparatus 120. The obtaining unit 122 outputs the obtained correspondence information to the calculating unit 123 and the selecting unit 124.

The calculating unit 123 first specifies frequencies available to the radio communications apparatus 110 at the position of the radio communications apparatus 110, based on the position of the radio communications apparatus 110 indicated by the route information output from the receiving unit 121 and based on the correspondence information output from the obtaining unit 122. For example, the calculating unit 123 searches the correspondence information for frequencies corresponding to the position of the radio communications apparatus 110 indicated by the route information, to thereby specify frequencies available to the radio communications apparatus 110 at the position of the radio communications apparatus 110.

For each of the specified frequencies, the calculating unit 123 calculates a predicted time taken for each frequency to become unavailable to the radio communications apparatus 110, based on the predicted route of the radio communications apparatus 110 indicated by the route information and based on the correspondence information. The calculating unit 123 notifies the selecting unit 124 of the specified frequencies and predicted time calculated for each of the specified frequencies.

Based on the predicted time notified by the calculating unit 123, the selecting unit 124 selects a frequency to be used by the radio communications apparatus 110 from among the frequencies notified by the calculating unit 123. For example, the selecting unit 124 preferentially selects from among the frequencies notified by the calculating unit 123, a frequency for which the predicted time notified by the calculating unit 123 is relatively longer. The selecting unit 124 outputs frequency information indicating the selected frequency to the transmitting unit 125. The transmitting unit 125 transmits to the radio communications apparatus 110, the frequency information output from the selecting unit 124.

According to the communications system 100 depicted in FIGS. 1A and 1B, the communications control apparatus 120 enables the radio communications apparatus 110 to set a frequency for which the predicted time taken to become unavailable is relatively long among frequencies available to the radio communications apparatus 110 at the position of the radio communications apparatus 110. This results in reduced frequency switching by the radio communications apparatus 110.

The selecting unit 124 of the communications control apparatus 120 notify the calculating unit 123 of frequencies selected as frequencies to be used by the radio communications apparatus 110 at the position of the radio communications apparatus 110. The calculating 123 specifies frequencies available to the radio communications apparatus 110 at a position where the frequencies notified by the selecting unit 124 become unavailable to the radio communications apparatus 110.

For each of the specified frequencies, the calculating unit 123 calculates a predicted time taken for the frequency to become unavailable to the radio communications apparatus 110 before the position is reached where the frequencies notified by the selecting unit 124 become unavailable to the radio communications apparatus 110. The calculating unit 123 notifies the selecting unit 124 of the specified frequencies and the predicted time calculated for each of the specified frequencies.

Based on the predicted times notified by the calculating unit 123, the selecting unit 124 selects from among the frequencies notified by the calculating unit 123, a frequency to be used by the radio communications apparatus 110 from the position where the already selected frequency becomes unavailable to the radio communications apparatus 110. The selecting unit 124 outputs to the transmitting unit 125, frequency information indicating a first frequency selected for the position of the radio communications apparatus 110 and a second frequency selected for a position where the first frequency becomes unavailable.

In this case, the frequency information has only to be information indicating the first frequency and the second frequency and indicating that the second frequency should be used after the first frequency. For example, assuming the first frequency and the second frequency to be F1 and F2, respectively, the frequency information can be list information such as {F1, F2}.

The communications unit 114 of the radio communications apparatus 110 performs radio communication using the first frequency indicated by the frequency information. When the first frequency becomes unavailable as a result of movement of the radio communications apparatus 110, the communications unit 114 performs radio communication using the second frequency indicated by the frequency information. This enables the radio communications apparatus 110 to set an available frequency and reduce frequency switching without again making an inquiry to the communications control apparatus 120 for available frequency when the frequency notified by the communications control apparatus 120 has become unavailable.

Although the case has been described where the communications control apparatus 120 issues a single frequency to be used when the frequency used at the position of the radio communications apparatus 110 has become unavailable, the communications control apparatus 120 may issue plural frequencies to be used when the frequency has become available.

Although a case has been described where the frequency is selected based on the predicted time for the frequency to become unavailable to the radio communications apparatus 110, configuration may be such that the frequency is selected based on a predicted movement distance of the radio communications apparatus 110 for the frequency to become unavailable to the radio communications apparatus 110.

For example, for each of the specified frequencies, the calculating unit 123 of the communications control apparatus 120 calculates a predicted movement distance of the radio communications apparatus 110 for the frequency to become unavailable to the radio communications apparatus 110. The calculating unit 123 notifies the selecting unit 124 of the specified frequencies and predicted movement distances respectively calculated for the specified frequencies.

Based on the predicted movement distances notified by the calculating unit 123, the selecting unit 124 selects a frequency to be used by the radio communications apparatus 110 from among the frequencies notified by the calculating unit 123. For example, the selecting unit 124 preferentially selects a frequency for which the predicted movement distance notified by the calculating unit 123 is relatively long among the frequencies notified by the calculating unit 123.

Thus, the communications control apparatus 120 enables the radio communications apparatus 110 to set a frequency for which the predicted movement distance of the radio communications apparatus 110 to become unavailable is relatively long among the frequencies available to the radio communications apparatus 110 at the position of the radio communications apparatus 110. This results in reduced frequency switching.

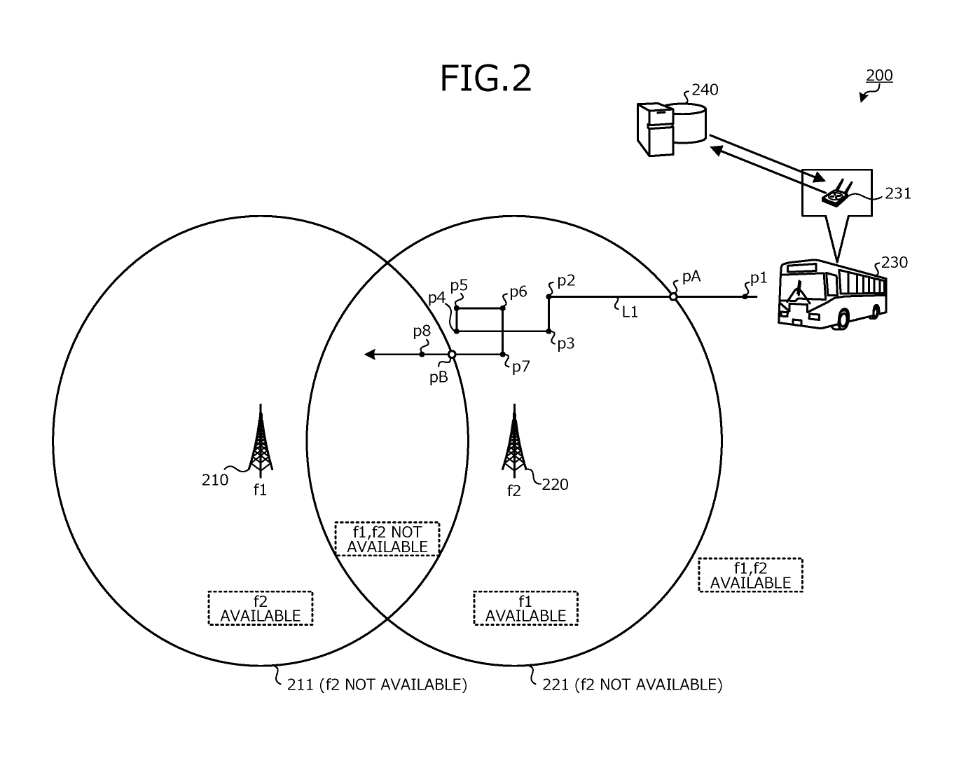

FIG. 2 is a diagram of a first application example of the communications system according to the first embodiment. The communications system 100 depicted in FIGS. 1A and 1B is applicable to a communications system 200 depicted in FIG. 2, for example. A bus vehicle 230 depicted in FIG. 2 is equipped with an access point 231. The radio communications apparatus 110 depicted in FIGS. 1A and 1B is applicable to the access point 231, for example. The communications control apparatus 120 depicted in FIGS. 1A and 1B is applicable to a WS database server 240, for example.

The access point 231 performs radio communication, for example, with communications terminals of passengers, etc., on the bus vehicle 230. The access point 231 has, as a backbone network, a wide area cellular network of 3rd generation (3G), long term evolution (LTE), etc., and performs radio communication with base stations of the backbone network using WS (frequencies). This enables the communications terminals of the passengers, etc., on the bus vehicle 230 to connect to the wide area cellular network by way of the access point 231.

The access point 231 can communicate with the WS database server 240. Various communication schemes such as LTE or 3G wide area cellular schemes, for example, are applicable to the communication between the access point 231 and the WS database server 240. The access point 231 transmits to the WS database server 240, predicted route information indicating a predicted route L1 of the bus vehicle 230. Since the access point 231 is equipped on the bus vehicle 230, the predicted route L1 is a predicted route of the access point 231.

The access point 231 receives from the WS database server 240, available frequency information indicating frequencies (WS) used by the access point 231. The access point 231 performs communications with the backbone network base stations using the frequencies indicated by the available frequency information received from the WS database server 240.

Frequencies available for radio communication by the access point 231 are assumed to be the frequencies f1 and f2 in the example depicted in FIG. 2. The frequencies f1 and f2 differ from each other. The frequency (WS) actually available to the access point 231 among the frequencies f1 and f2 differs depending on the position of the access point 231.

For example, a television station 210 communicates using the frequency f1 in an area 211. Therefore, the frequency f1 is not available to the access point 231 in the area 211. A television station 220 communicates using the frequency f2 in an area 221. Hence, the frequency f2 is not available to the access point 231 in the area 221.

Passage points p1 to p8 designate positions on the predicted route L1 of the access point 231. The passage point p1 is in neither the area 211 nor the area 221. Thus, the access point 231 can use the frequencies f1 and f2 at the passage point p1. The access points p2 to p7 are not in the area 211 but are in the area 221. Therefore, at the passage points p2 to p7, the access point 231 can use the frequency f1 but cannot use the frequency f2. The passage point p8 is in both the area 211 and the area 221. Hence, at the passage point p8, the access point 231 cannot use the frequencies f1 and f2.

A boundary point pA is a position on the predicted route L1 where the access point 231 enters the area 221. A boundary point pB is a position on the predicted route L1 where the access point 231 enters the area 211.

For example, when the access point 231 is located at the passage point p1, the frequencies f1 and f2 are available to the access point 231. If the access point 231 sets the frequency f2 at the passage point p1, the frequency f2 becomes unavailable at the boundary point pA and consequently, the access point 231 has to perform frequency switching. On the other hand, if the access point 231 sets the frequency f1 at the passage point p1, the frequency f1 is available until the boundary point pB and consequently, the access point 231 need not perform frequency switching until the boundary point pB.

Accordingly, the WS database server 240 causes the access point 231 to set the frequency f1 for which the predicted time for the frequency to become unavailable is longer among the frequencies f1 and f2 available to the access point 231 at the passage point p1. This enables a reduction of the frequency switching by the access point 231.

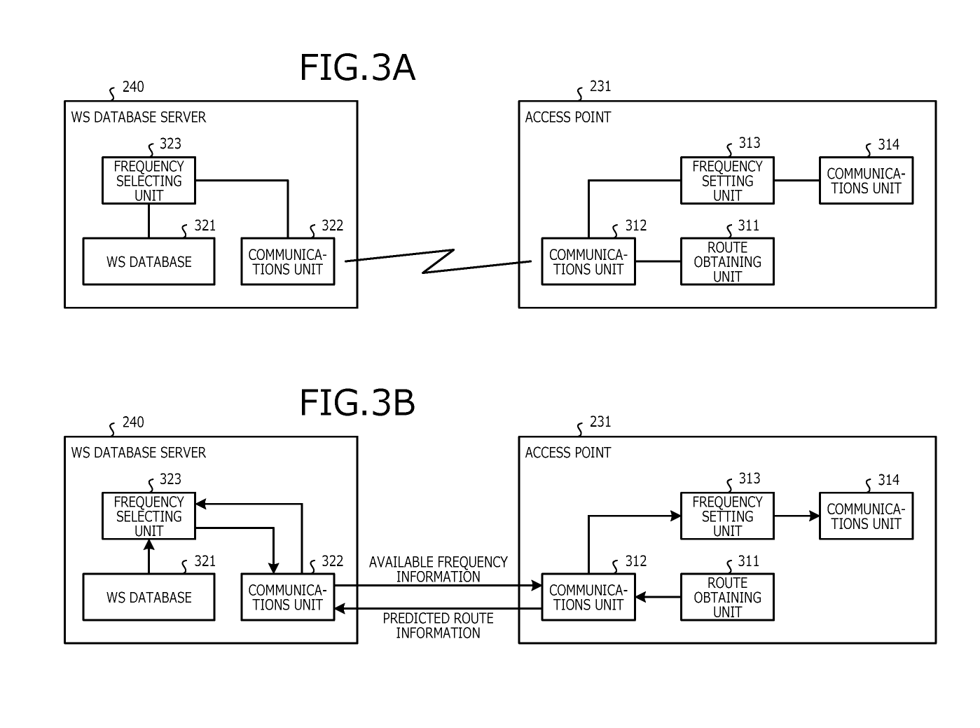

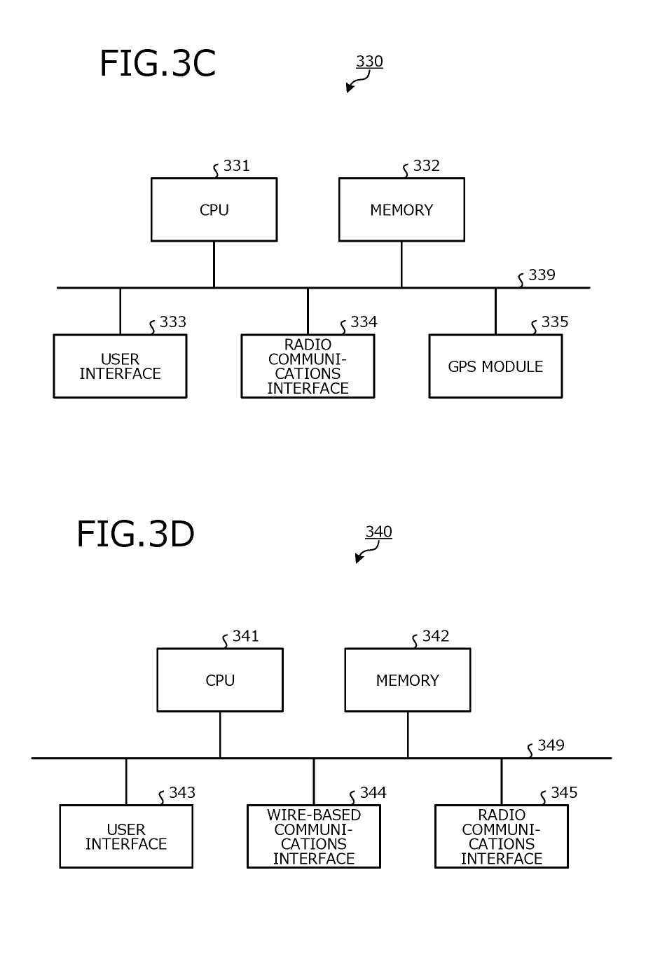

FIG. 3A is a diagram of an example of configuration of the communications system depicted in FIG. 2. FIG. 3B is a diagram of an example of signal flow in the communications system depicted in FIG. 3A. In FIGS. 3A and 3B, parts identical to those depicted in FIG. 2 are designated by the same reference letters or numerals used in FIG. 2 and will not again be described.

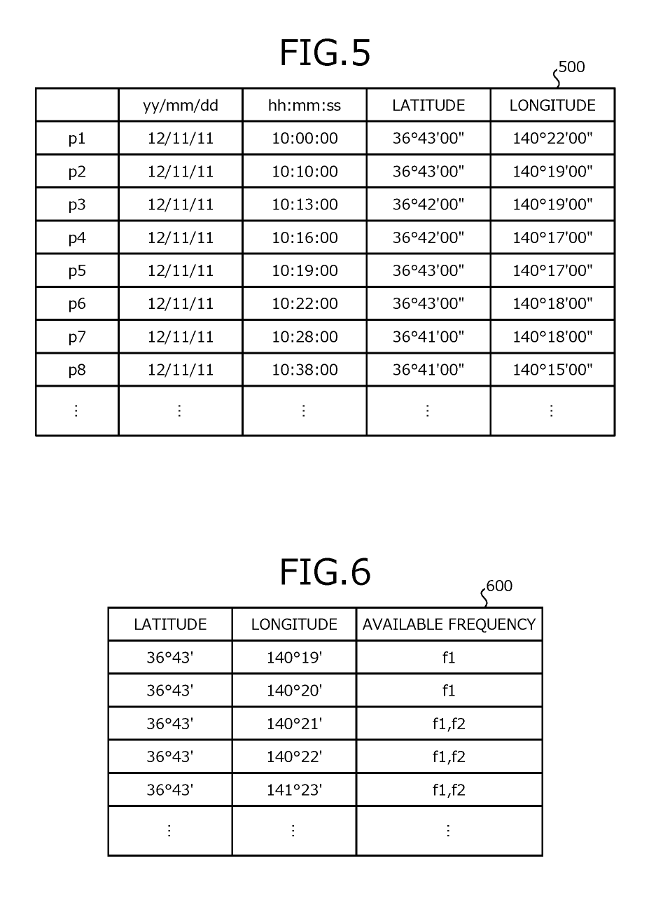

As depicted in FIGS. 3A and 3B, the access point 231 includes, for example, a route obtaining unit 311, a communications unit 312, a frequency setting unit 313, and a communications unit 314. The route obtaining unit 311 obtains predicted route information (see, e.g., FIG. 5) indicating the position of the access point 231, and the predicted route L1 (see, e.g., FIG. 2) of the access point 231.

The memory of the access point 231 stores information indicating the predicted route, and the route obtaining unit 311 obtains from the memory of the access point 231, the information indicating the predicted route. The route obtaining unit 311 may obtain from a car navigation system, etc., of the bus vehicle 230, the information indicating the predicted route. The route obtaining unit 311 may use a global positioning system (GPS), for example, to obtain information indicating the position of the access point 231. The route obtaining unit 311 outputs the obtained predicted route information to the communications unit 312.

The communications unit 312 performs radio communication with the WS database server 240. For example, the communications unit 312 transmits to the WS database server 240, the predicted route information output from the route obtaining unit 311. The communications unit 312 receives available frequency information transmitted from the WS database server 240. The communications unit 312 outputs the received available frequency information to the frequency setting unit 313.

The frequency setting unit 313 sets the frequency used for radio communication by the communications unit 314 to a frequency indicated by the available frequency information output from the route obtaining unit 311. The communications unit 314 performs radio communication using the frequency set by the frequency setting unit 313. For example, the communications unit 314 relays, via radio communication, communication between communications terminals on the bus vehicle 230 and base stations. The communications units 312 and 314 may be realized by a single communications unit.

The obtaining unit 111 depicted in FIGS. 1A and 1B can be realized, for example, by the route obtaining unit 311. The transmitting unit 112 and the receiving unit 113 depicted in FIGS. 1A and 1B can be realized, for example, by the communications unit 312. The communications unit 114 depicted in FIGS. 1A and 1B can be realized, for example, by the frequency setting unit 313 and the communications unit 314.

As depicted in FIGS. 3A and 3B, the WS database server 240 includes a WS database 321, a communications unit 322, and a frequency selecting unit 323. The WS database 321 stores correspondence information associating the positions of the access point 231 with the frequencies available to the access point 231.

The communications unit 322 performs radio communication with the access point 231. For example, the communications unit 322 receives predicted route information transmitted from the access point 231. The communications unit 322 outputs the received predicted route information to the frequency selecting unit 323. The communications unit 322 transmits to the access point 231, available frequency information output from the frequency selecting unit 323.

The frequency selecting unit 323 specifies, as available frequencies of the access point 231, frequencies available to the access point 231 at the current position of the access point 231. For example, the frequency selecting unit 323 specifies the available frequencies of the access point 231, based on the current position of the access point 231 indicated by the predicted route information output from the communications unit 322 and based on the correspondence information stored in the WS database 321.

For each of the specified available frequencies, the frequency selecting unit 323 calculates a predicted time for the next frequency switching by the access point 231 if the access point 231 were to set the frequency. The frequency selecting unit 323 then selects, as the frequency to be used by the access point 231, an available frequency for which the calculated predicted time is greatest among the specified available frequencies. The frequency selecting unit 323 outputs to the communications unit 322, the available frequency information indicating the selected frequency to be used.

The receiving unit 121 and the transmitting unit 125 depicted in FIGS. 1A and 1B can be realized for example by the communications unit 322. The obtaining unit 122 depicted in FIGS. 1A and 1B can be realized for example by the WS database 321. The calculating unit 123 and the selecting unit 124 depicted in FIGS. 1A and 1B can be realized for example by the frequency selecting unit 323.

FIG. 3C is a diagram of an example of hardware configuration of the access point. The access point 231 depicted in FIGS. 3A and 3B, for example, can be realized by an information processing apparatus 330 depicted in FIG. 3C. The information processing apparatus 330 includes a CPU 331, memory 332, a user interface 333, a radio communications interface 334, and a GPS module 335. The CPU 331, the memory 332, the user interface 333, the radio communications interface 334, and the GPS module 335 are connected by a bus 339.

The CPU 331 (central processing unit) governs overall control of the information processing apparatus 330. Further, the information processing apparatus 330 may include the CPU 331 in plural. The memory 332, for example, includes main memory and auxiliary memory. The main memory, for example, is RAM (random access memory) and is used as a work area of the CPU 331. The auxiliary memory, for example, is non-volatile memory such as a magnetic disk and flash memory. The auxiliary memory stores various types of programs that cause the information processing apparatus 330 to operate. Programs stored by the auxiliary memory are loaded to the main memory and are executed by the CPU 331.

The user interface 333, for example, includes an input device that receives operational input from the user and an output device that outputs information to the user. The input device, for example, can be realized by a key (e.g., a keyboard) or a remote controller. The output device, for example, can be realized by a display or a speaker. Further, the input device and the output device may be realized by a touch panel and the like. The user interface 333 is controlled by the CPU 331.

The radio communications interface 334, for example, is a communications interface that performs radio communication with external apparatuses of the information processing apparatus 330. The radio communications interface 334 is controlled by the CPU 331.

The GPS module 335 is a module that obtains information indicating the current position of the information processing apparatus 330. The GPS module 335 is controlled by the CPU 331.

The route obtaining unit 311 depicted in FIGS. 3A and 3B, for example, can be realized by the CPU 331, the memory 332, and the GPS module 335. The communications units 312 and 314 depicted in FIGS. 3A and 3B, for example, can be realized by the CPU 331 and the radio communications interface 334. The frequency setting unit 313 depicted in FIGS. 3A and 3B, for example, can be realized by the CPU 331.

FIG. 3D is a diagram of an example of hardware configuration of the WS database server. The WS database server 240 depicted in FIGS. 3A and 3B, for example, can be realized by the information processing apparatus 340 depicted in FIG. 3D. The information processing apparatus 340 includes a CPU 341, memory 342, user interface 343, a wire-based communications interface 344, and a radio communications interface 345. The CPU 341, the memory 342, the user interface 343, the wire-based communications interface 344, and the radio communications interface 345 are connected by a bus 349.

The CPU 341 governs overall control of the information processing apparatus 340. Further, the information processing apparatus 340 may include the CPU 341 in plural. The memory 342, for example, includes main memory and auxiliary memory. The main memory, for example, is RAM and is used as a work area of the CPU 341. The auxiliary memory, for example, is non-volatile memory such as a magnetic disk, an optical disk, and flash memory. The auxiliary memory stores various types of programs that cause the information processing apparatus 340 to operate. Programs stored by the auxiliary memory are loaded to the main memory and executed by the CPU 341.

The user interface 343, for example, includes an input device that receives operational input from the user and an output device that outputs information to the user. The input device, for example, can be realized by a key (e.g., a keyboard) or a remote controller. The output device, for example, can be realized by a display or a speaker. Further, the input device and the output device may be realized by a touch panel and the like. The user interface 343 is controlled by the CPU 341.

The wire-based communications interface 344, for example, is a communications interface that communicates with external apparatuses (e.g., higher order system) of the information processing apparatus 340 by cable. The wire-based communications interface 344 is controlled by the CPU 341.

The radio communications interface 345, for example, is a communications interface that performs radio communication with external apparatuses of the information processing apparatus 340. The radio communications interface 345 is controlled by the CPU 341.

The communications unit 322 depicted in FIGS. 3A and 3B, for example, can be realized by the CPU 341 and the radio communications interface 345. The WS database 321 depicted in FIGS. 3A and 3B, for example, can be realized by the memory 342. The frequency selecting unit 323 depicted in FIGS. 3A and 3B, for example, can be realized by the CPU 341.

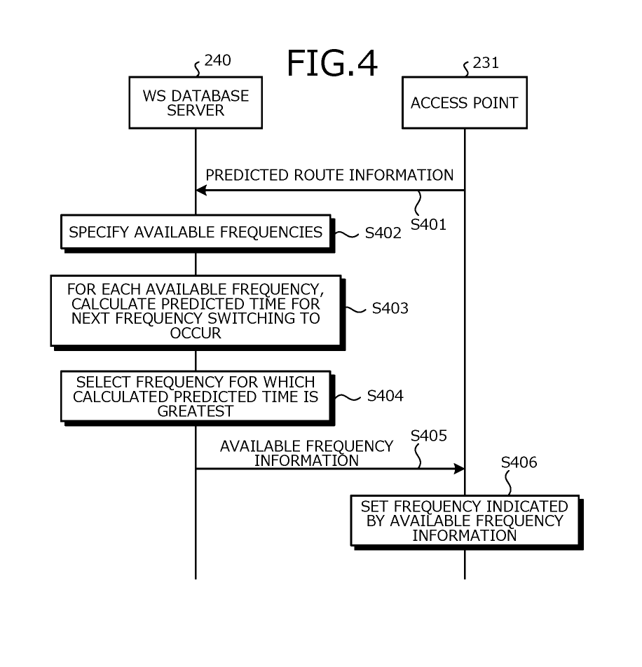

FIG. 4 is a sequence diagram of an operation example of the communications system depicted in FIG. 2. The communications system 200 depicted in FIG. 2 operates, for example, as indicated by the steps depicted in FIG. 4. First, the access point 231 transmits predicted route information of the access point 231 to the WS database server 240 (step S401).

The WS database server 240 then specifies available frequencies corresponding to the current position of the access point 231, based on the predicted route information transmitted at step S401 and based on the correspondence information (step S402). For each of the available frequencies specified at step S402, the WS database server 240 then calculates a predicted time for the next frequency switching by the access point 230 to occur if the WS database server 240 causes the access point 231 to set the available frequency (step S403).

The WS database server 240 selects from among the available frequencies specified at step S402, the frequency for which the predicted time calculated at step S403 is greatest (step S404). The WS database server 240 transmits available frequency information indicating the frequency selected at step S404 to the access point 231 (step S405).

The access point 231 sets the frequency indicated by the available frequency information transmitted at step S405, as a frequency to be used for radio communication by the access point 231 (step S406), and terminates a series of the operations.

The above operations enable the access point 231 to set a frequency for which the predicted time of becoming unavailable is longer among frequencies available to the access point 231 at the current position of the access point 231. As a result, frequency switching by the access point 231 can be reduced.

The operations depicted in FIG. 4 are executed, for example, at the time of powering on of the access point 231. The timing at which the operations depicted in FIG. 4 are executed is not limited hereto. For example, the operations depicted in FIG. 4 may be executed every time the frequency being used by the access point 231 becomes unavailable as a result of movement of the access point 231. This can reduce frequency switching, not only at the time of powering on.

The operations depicted in FIG. 4 may be executed every time the predicted route L1 of the access point 231 changes. The operations depicted in FIG. 4 may be executed periodically. This enables the frequency switching by the access point 231 to be reduced, irrespective of a change in the predicted route L1 of the access point 231 due to rerouting, etc.

FIG. 5 is a diagram of an example of predicted route information transmitted by an access point. The access point 231 transmits to the WS database server 240, for example, predicted route information 500 depicted in FIG. 5 as the predicted route information. In the predicted route information 500, date (yy/mm/dd), time (hh:mm:ss), latitude, and longitude are correlated with one another for each passage point (passage points p1 to p8, . . . ) on the predicted route L1.

For example, the predicted route information 500 indicates that the access point 231 is scheduled to pass through the passage point p1 at 10:00:00 on Dec. 11, 2011, latitude (36 [degrees], 43′00″), and longitude (140 [degrees], 22′00″). In this manner, the predicted route information 500 can be position information arranged in time series.

The predicted route information 500 is, for example, information indicating positions on the predicted route L1 and predicted times of passing through the positions on the predicted route L1. This enables the WS database server 240 to calculate a predicted time and a predicted movement distance for a given frequency to become unavailable to the access point 231. When the WS database server 240 calculates the predicted movement distance for the given frequency to become unavailable to the access point 231, the predicted route information 500 may omit the hour (date and time).

FIG. 6 is a diagram of an example of correspondence information stored in a WS database. The WS database server 240 stores, for example, correspondence information 600 depicted in FIG. 6. In the correspondence information 600, frequencies available to the access point 231 are correlated with combinations of the latitude and the longitude.

For example, the correspondence information 600 indicates that the frequency f1 is a frequency available to the access point 231 at the position of latitude (36 [degrees], 43′) and longitude (140 [degrees], 22′).

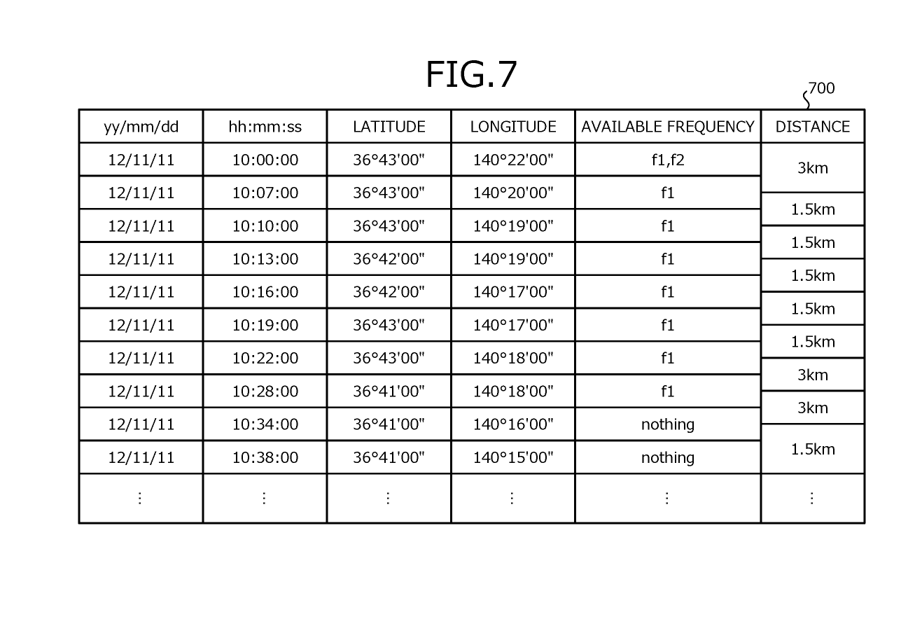

FIG. 7 is a diagram of an example of frequencies available at positions on the predicted route depicted in FIG. 2. The frequency selecting unit 323 of the WS database server 240 creates a table 700 depicted in FIG. 7 through calculations based on predicted route information (see, e.g., FIG. 5) output from the communications unit 322 and based on correspondence information (see, e.g., FIG. 6) stored in the WS database 321.

In the table 700, frequencies available to the access point 231 are correlated with each passage point of the access point 231 based on the predicted route indicated by the predicted route information. The passage points of the table 700 include, in addition to the passage points p1 to p8, . . . , indicated by the predicted route information, passage points supplemented based on the passage points p1 to p8, . . . .

The table 700 includes distances between the passage points of the access point 231, correlated with the passage points. The distances between the passage points can be calculated based on the latitudes and longitudes of the passage points.

The approximate current time is assumed to be 10:00:00 on Dec. 11, 2011. In this case, the current position of the access point 231 is latitude (36 [degrees], 43′00″) and longitude (140 [degrees], 22′00″). The frequency selecting unit 323 specifies the available frequencies f1 and f2 corresponding to the current position of the access point 23, based on the created table 700.

For each of the specified frequencies f1 and f2, the frequency selecting unit 323 calculates based on the table 700, a predicted time for the next frequency switching to occur by the access point 231 if the access point 231 sets the frequency.

In the example depicted in FIG. 7, if the frequency f1 is set in the access point 231, the frequency f1 remains available until 10:34:00 of the same date and consequently, the predicted time for the frequency switching to occur by the access point 231 is 34 minutes. If the frequency f2 is set in the access point 231, the frequency f2 is available until 10:07:00 of the same date and consequently, the predicted time for the frequency switching to occur by the access point 231 is 7 minutes.

The frequency selecting unit 323 thus selects, as the frequency to be used by the access point 231, the frequency f1 for which the predicted time for the frequency switching to occur by the access point 231 is longest among the specified frequencies f1 and f2.

Although the example depicted in FIG. 2 has been described in a case where the frequency to be used is selected based on the predicted time for the frequency switching to occur, configuration may be such that the frequency to be used is selected based on the predicted movement distance of the access point 231 for the frequency switching to occur.

For example, for each specified available frequency, the frequency selecting unit 323 calculates a predicted movement distance of the access point 231 for the next frequency switching to occur by the access point 231 if the access point 231 sets the available frequency. The frequency selecting unit 323 then selects, as the frequency to be used by the access point 231, the available frequency for which the calculated predicted movement distance is greatest among the specified available frequencies.

In this case, if the frequency f1 is set in the access point 231 in the example depicted in FIG. 7, the frequency f1 remains available until the position of latitude (36 [degrees], 41′00″) and longitude (140 [degrees], 16′00″). Accordingly, the predicted movement distance of the access point 231 for the frequency switching to by in the access point 231 is 3+1.5+1.5+1.5+1.5+1.5+3+3=16.5 [km].

If the frequency f2 is set in the access point 231, the frequency f2 is available until the position of latitude (36 [degrees], 43′00″) and longitude (140 [degrees], 20′00″). Accordingly, the predicted movement distance of the access point 231 for the frequency switching to occur in the access point 231 is 3 [km].

The frequency selecting unit 323 thus selects, as the frequency used by the access point 231, the frequency f1 for which the predicted movement distance for the frequency switching to occur by the access point 231 is longest among the specified frequencies f1 and f2.

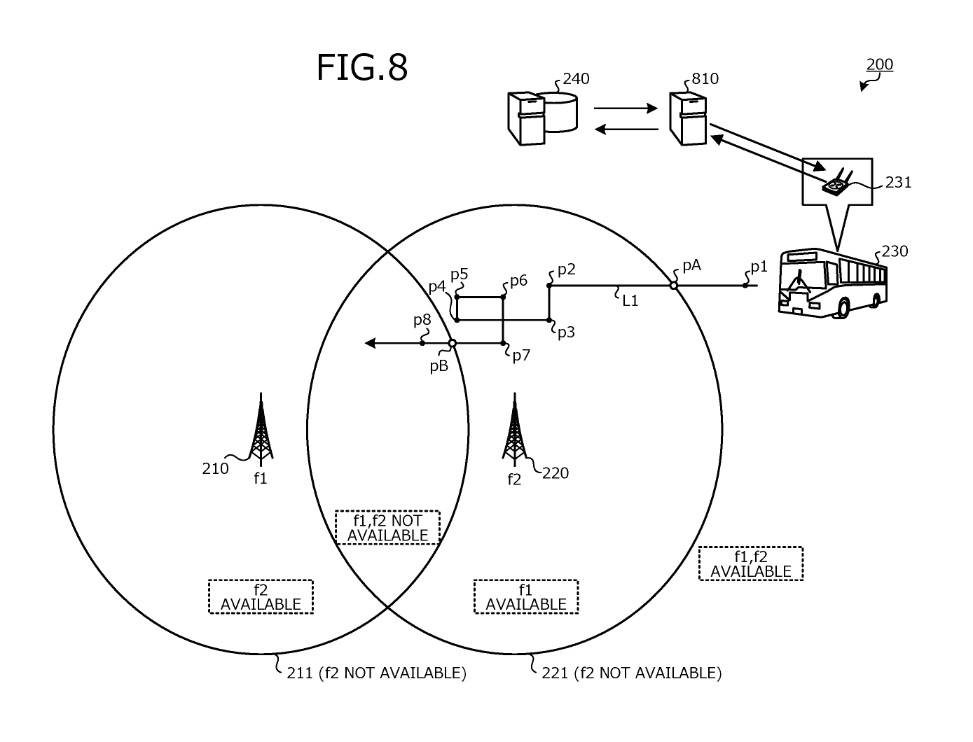

FIG. 8 is a diagram of a second application example of the communications system according to the first embodiment. In FIG. 8, parts identical to those depicted in FIG. 2 are designated by the same reference letters or numerals used in FIG. 2 and will not again be described. As depicted in FIG. 8, the communications system 200 includes a frequency management apparatus 810, in addition to the configuration depicted in FIG. 2. In this case, the communications control apparatus 120 depicted in FIGS. 1A and 1B are applicable to the frequency management apparatus 810, for example.

The frequency management apparatus 810 can communicate with the access point 231 and with the WS database server 240. Radio communication, for example, can be used for communication between the frequency management apparatus 810 and the access point 231. Wire-based communication, for example, can be used for communication between the frequency management apparatus 810 and the access point 240. In this case, direct communication is not necessarily required between the WS database server 240 and the access point 231.

The access point 231 transmits to the frequency management apparatus 810, predicted route information indicating the predicted route L1. The access point 231 receives from the frequency management apparatus 810, available frequency information indicating frequencies (WS) to be used by the access point 231. The access point 231 performs radio communication with base stations of the backbone network using frequencies indicated by the available frequency information received from the frequency management apparatus 810.

The frequency management apparatus 810 receives from the WS database server 240, information indicating the WS available to the access point 231. The frequency management apparatus 810 transmits to the WS database server 240, position information indicating the position of the access point 231 indicated by the correspondence information 600 received from the access point 231.

Such a function of selecting the frequencies to be used by the access point 231 notifying the access point 231 of them may be realized by a communications control apparatus (e.g., frequency management apparatus 810) different from the WS database server 240. The WS database server 240 and the frequency management apparatus 810 may be managed by respectively different business operators.

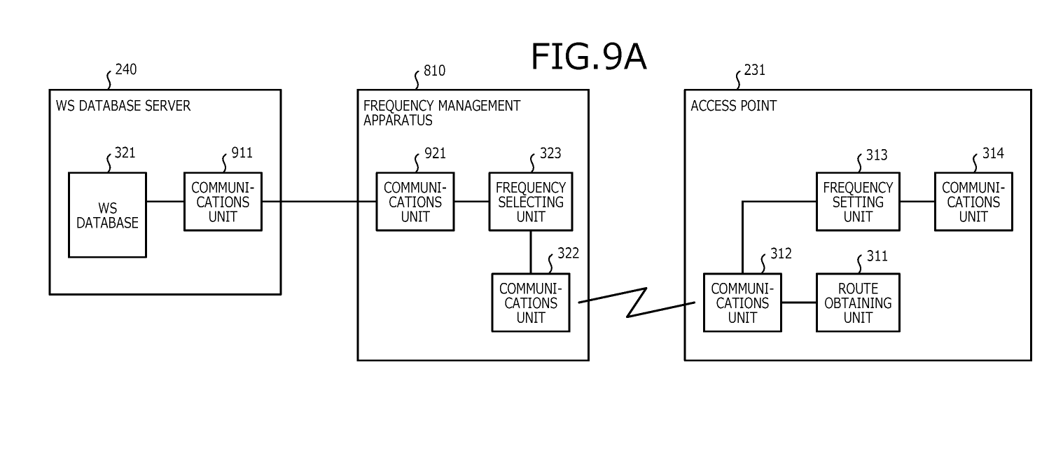

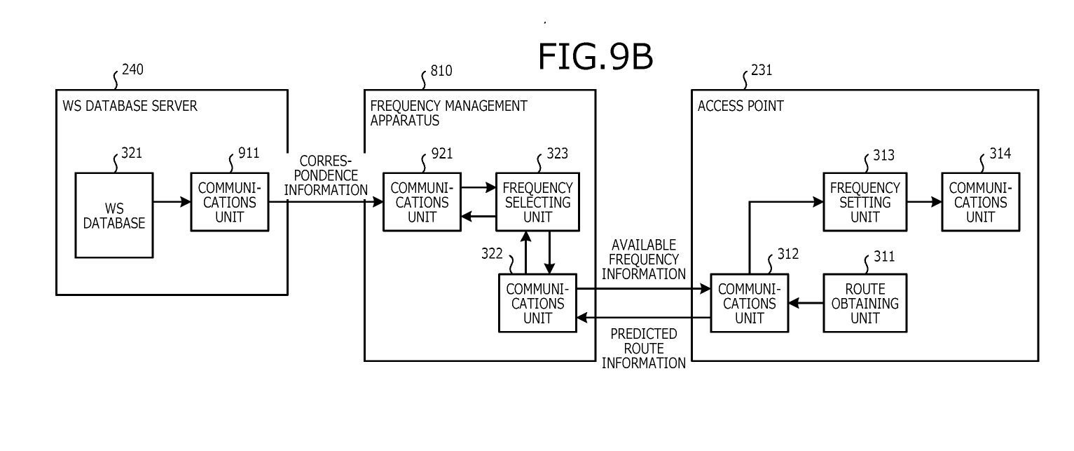

FIG. 9A is a diagram of an example of configuration of the communications system depicted in FIG. 8. FIG. 9B is a diagram of an example of signal flow in the communications system depicted in FIG. 9A. In FIGS. 9A and 9B, parts identical to those depicted in FIGS. 3A and 3B are designated by the same reference letters or numerals used in FIGS. 3A and 3B and will not again be described.

As depicted in FIGS. 9A and 9B, the WS database server 240 depicted in FIG. 8 includes a communications unit 911 and the WS database 321. The communications unit 911 transmits correspondence information stored in the WS database 321 to the frequency management apparatus 810. Wire-based communication, for example, can be used for communication between the communications unit 911 and the frequency management apparatus 810.

The frequency management apparatus 810 includes a communications unit 921, the frequency selecting unit 323, and the communications unit 322. The communications unit 921 receives the correspondence information transmitted from the WS database server 240. The communications unit 921 outputs the received correspondence information to the frequency selecting unit 323.

The frequency selecting unit 323 specifies available frequencies of the access point 231, based on the predicted route information output from the communications unit 322 and based on the correspondence information output from the communications unit 921. For each of the specified available frequencies, the frequency selecting unit 323 calculates based on the correspondence information output from the communications unit 921, a predicted time (or a predicted movement distance) for the next frequency switching to occur by the access point 231 if the access point 231 sets the frequency.

The frequency management apparatus 810 depicted in FIGS. 9A and 9B can be realized, for example, by the information processing apparatus 340 depicted in FIG. 3D. In this case, the communications unit 322 depicted in FIGS. 9A and 9B can be realized for example by the CPU 341 and the radio communications interface 345.

The frequency selecting unit 323 depicted in FIGS. 9A and 9B can be realized, for example, by the CPU 341. The communications unit 921 depicted in FIGS. 9A and 9B can be realized, for example, by the CPU 341 and the wire-based communications interface 344.

The WS database server 240 depicted in FIGS. 9A and 9B can be realized, for example, by the information processing apparatus 340 depicted in FIG. 3D. In this case, however, the radio communications interface 345 depicted in FIG. 3D may be omitted.

The communications unit 911 depicted in FIGS. 9A and 9B can be realized, for example, by the CPU 341 and the wire-based communications interface 344. The WS database 321 depicted in FIGS. 9A and 9B can be realized, for example, by the memory 342.

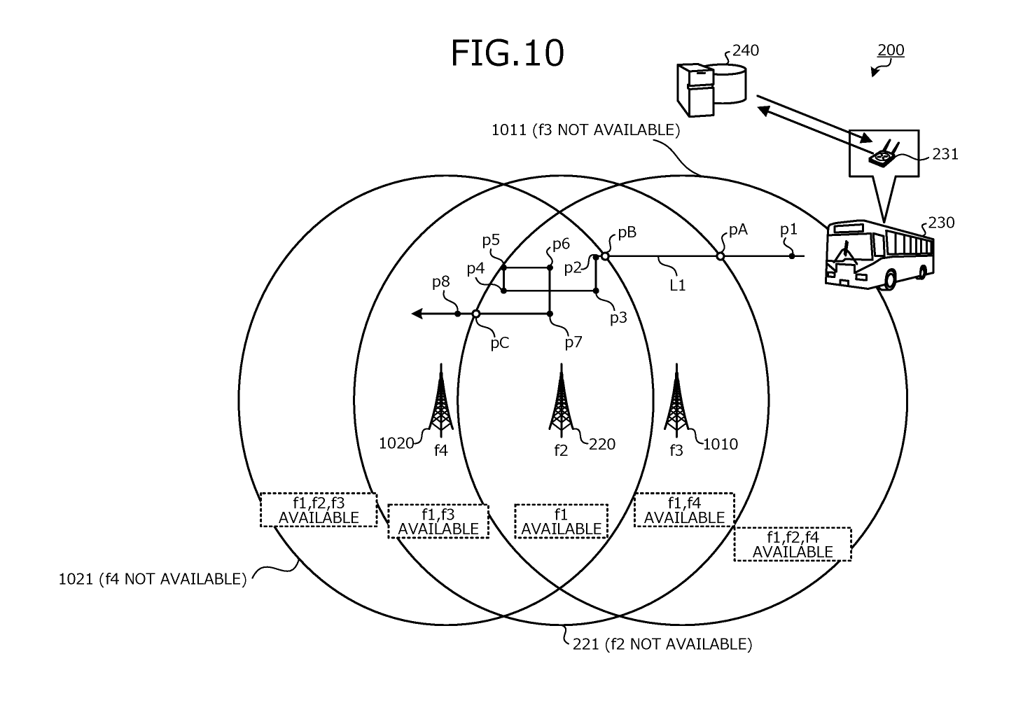

FIG. 10 is a diagram of a third application example of the communications system according to the first embodiment. In FIG. 10, parts identical to those depicted in FIG. 2 are designated by the same reference letters or numerals used in FIG. 2 and will not again be described. The example depicted in FIG. 10 assumes that the frequencies available for radio communication by the access point 231 are frequencies f1 to f4. The frequencies f1 to f4 are frequencies differing from one another.

The access point 231 can perform radio communication using plural frequencies. Carrier aggregation in LTE or channel bonding in WiFi can be used for radio communication using plural frequencies, for example.

A television station 1010 communicates using the frequency f3 in an area 1021. Therefore, the frequency f3 is unavailable to the access point 231 in the area 1011. A television station 1020 communicates using the frequency f4 in an area 1021. Therefore, the frequency f4 is unavailable to the access point 231 in the area 1021.

In the example depicted in FIG. 10, the passage point p1 is not in the areas 221 and 1021 but is in the area 1011. Thus, the frequencies f1 and f2, and f4 are available to the access point 231 at the passage point p1. The passage points p2 to p7 are in the areas 221, 1011, and 1021. Thus, the frequency f1 is available to the access point 231 at the passage points p2 to p7. The passage point p8 is not in the area 1011 but is in the areas 221 and 1021. Therefore, the frequencies f1 and f3 are available to the access point 231 at the passage point p8.

The boundary point pA is a position on the predicted route L1 where the access point 231 enters the area 221. The boundary point pB is a position on the predicted route L1 where the access point 231 enters the area 1021. A boundary point pC is a position on the predicted route L1 where the access point 231 leaves the 1011.

For example, if the access point 231 is located at the passage point p1, frequencies available to the access point 231 are the frequencies f1 and f2, and f4. If the access point 231 sets the frequency f1 at the passage point p1, no frequency switching by the access point 231 occurs. If the access point 231 sets the frequency f2 at the passage point p1, the frequency f2 becomes unavailable at the boundary point pA resulting in frequency switching by the access point 231. If the access point 231 sets the frequency f4 at the passage point p1, the frequency f4 becomes unavailable at the boundary point pB resulting in frequency switching by the access point 231.

The WS database server 240 thus causes the access point 231 to set the frequency for which the predicted time for the frequency to become unavailable is longest among the frequencies f1 and f2, and f4 available to the access point 231 at the passage point p1. For example, if the access point 231 performs radio communication using two frequencies at the same time, the WS database server 240 causes the access point 231 to set the two frequencies for which the predicted times to become unavailable are longest. As a result, frequency switching by the access point 231 can be reduced.

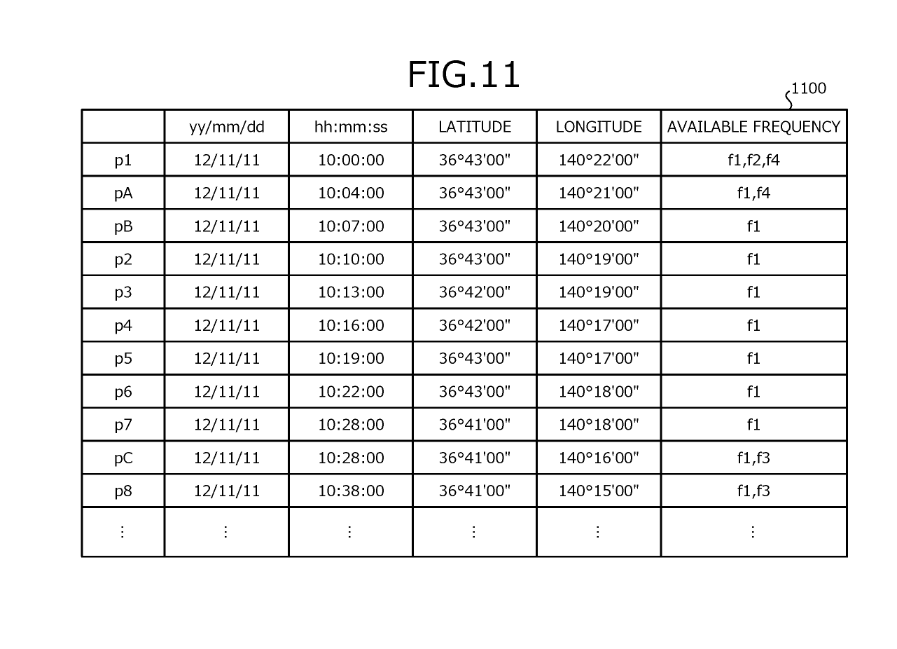

FIG. 11 is a diagram of an example of frequencies available at positions on the predicted route depicted in FIG. 10. The frequency selecting unit 323 of the WS database server 240 depicted in FIG. 10 creates, for example, a table 1100 depicted in FIG. 11 through calculations based on the predicted route information output from the communications unit 322 and based on the correspondence information stored in the WS database 321.

In the table 1100, similar to the table 700 depicted in FIG. 7, frequencies available to the access point 231 are correlated with each passage point of the access point 231 based on the predicted route indicated by the predicted route information.

In the example depicted in FIG. 11, if the frequency f1 is set in the access point 231, the frequency f1 remains available until the passage point p8 at the terminal end of the predicted route L1, resulting in the longest predicted time for frequency switching to occur by the access point 231. If the frequency f2 is set in the access point 231, the frequency f2 is available until 10:04:00 of the same date, and the predicted time for frequency switching to occur by the access point 231 is 4 min. If the frequency f4 is set in the access point 231, the frequency f4 is available until 10:07:00 of the same date, and the predicted time for frequency switching to occur by the access point 231 is 7 min.

The frequency selecting unit 323, therefore, selects, as the frequencies to be used by the access point 231, the two frequencies f1 and f4 for which the longest predicted times for frequency switching to occur by the access point 231 are longest among the specified frequencies f1 and f2, and f4.

In this manner, according to the first embodiment, the radio communications apparatus can set a frequency for which the predicted time for the frequency to become unavailable is relatively long among the frequencies available to the radio communications apparatus at the position of the radio communications apparatus. Alternatively, the radio communications apparatus can set a frequency for which the predicted movement distance to become unavailable, among frequencies available to the radio communications apparatus at the position of the radio communications apparatus. As a result, the number of times of frequency switching can be reduced in the radio communications apparatus.

Parts of a second embodiment differing from the first embodiment will be described.

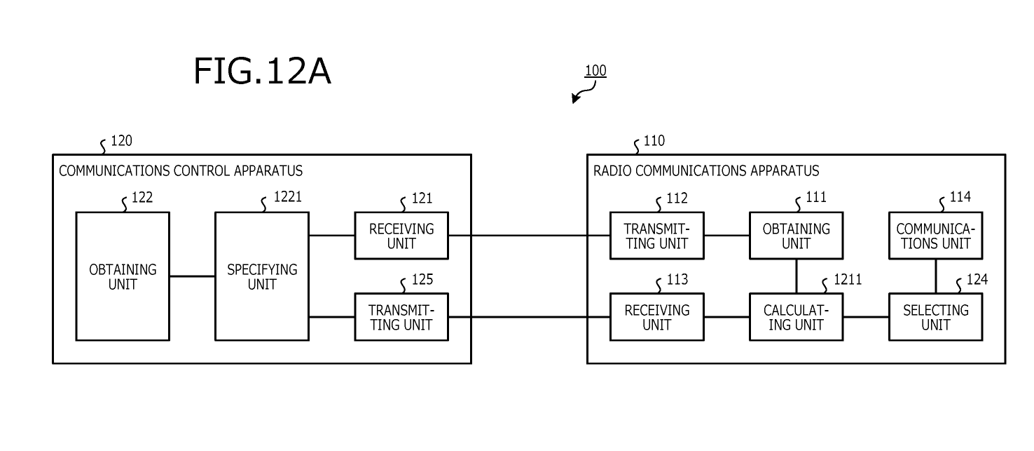

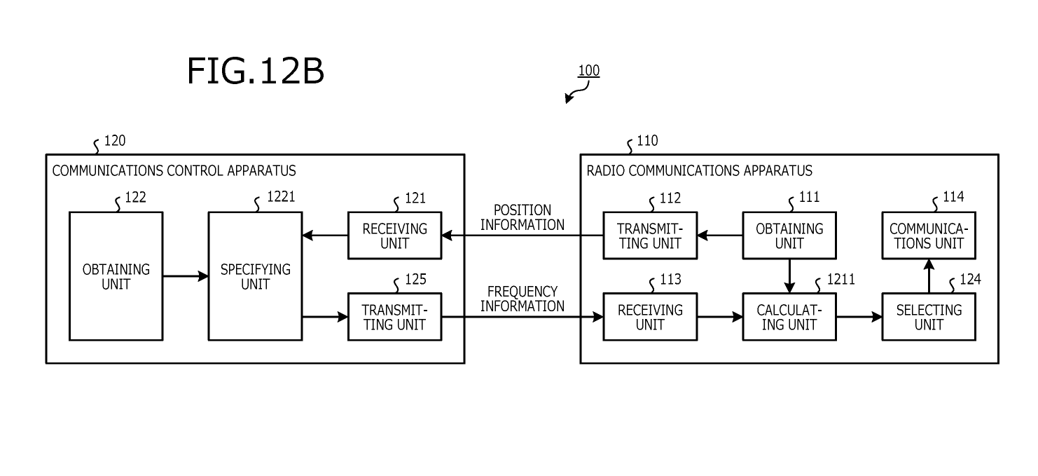

FIG. 12A is a diagram of an example of the communications system according to a second embodiment. FIG. 12B is a diagram of an example of signal flow in the communications system depicted in FIG. 12A. In FIGS. 12A and 12B, parts identical to those depicted in FIGS. 1A and 1B are designated by the same reference letters or numerals used in FIGS. 1A and 1B and will not again be described.

The radio communications apparatus 110 according to the second embodiment includes the obtaining unit 111, the transmitting unit 112, the receiving unit 113, a calculating unit 1211, the selecting unit 124, and the communications unit 114. The obtaining unit 111 obtains position information indicating the position of the radio communications apparatus 110. The obtaining unit 111 then outputs the obtained position information to the transmitting unit 112.

The obtaining unit 111 obtains route information indicating a predicted route of the radio communications apparatus 110 in the future. Based on the obtained route information, the obtaining unit 111 then obtains history information indicating a history of switching frequencies used for radio communication by the radio communications apparatus 110, at positions on the predicted route of the radio communications apparatus 110. The obtaining unit 111 outputs the obtained history information to the calculating unit 1211.

The transmitting unit 112 transmits to the communications control apparatus 120 (radio communications apparatus), the position information output from the obtaining unit 111. The receiving unit 113 receives frequency information transmitted from the communications control apparatus 120. The receiving unit 113 then outputs the received frequency information to the calculating unit 1211.

For each of the frequencies indicated by the frequency information output from the receiving unit 113, the calculating unit 1211 calculates a predicted time for the frequency to become unavailable to the radio communications apparatus 110, based on the history information output from the obtaining unit 111. The calculating unit 1211 then notifies the selecting unit 124 of the frequencies indicated by the frequency information and the predicted time calculated for each frequency indicated by the frequency information.

Based on the predicted time notified by the calculating unit 1211, the selecting unit 124 selects a frequency to be used by the radio communications apparatus 110 among the frequencies notified by the calculating unit 1211. The selecting unit 124 then notifies the communications unit 114 of the selected frequency. The communications unit 114 performs radio communication using the frequency notified by the selecting unit 124.

The communications control apparatus 120 includes the receiving unit 121, a specifying unit 1221, the obtaining unit 122, and the transmitting unit 125. The receiving unit 121 receives position information transmitted from the radio communications apparatus 110. The receiving unit 121 then outputs the received position information to the specifying unit 1221. The obtaining unit 122 outputs obtained correspondence information to the specifying unit 1221.

The specifying unit 1221 specifies frequencies available to the radio communications apparatus 110 at the position of the radio communications apparatus 110, based on the position indicated by the position information output from the receiving unit 121 and based on the correspondence information output from the obtaining unit 122. For example, the specifying unit 1221 searches the correspondence information for frequencies corresponding to the position of the radio communications apparatus 110 indicated by the position information, to thereby specify the frequencies available to the radio communications apparatus 110 at the position of the radio communications apparatus 110.

The specifying unit 1221 then outputs to the transmitting unit 125, frequency information indicating the specified frequencies. The transmitting unit 125 transmits to the radio communications apparatus 110, the frequency information output from the specifying unit 1221.

The communications system 100 depicted in FIGS. 12A and 12B enables the radio communications apparatus 110 to set a frequency for which the predicted time for the frequency to become unavailable is relatively long among the frequencies available to the radio communications apparatus 110 at the position of the radio communications apparatus 110. As a result, frequency switching by the radio communications apparatus 110 can be reduced.

Although a case has been described where the frequency is selected based on the predicted time for the frequency to become unavailable to the radio communications apparatus 110, configuration may be such that the frequency is selected based on a predicted movement distance of the radio communications apparatus 110 for the frequency to become unavailable to the radio communications apparatus 110.

For example, for each of the specified frequencies, the calculating unit 1211 of the communications apparatus 110 calculates a predicted movement distance of the radio communications apparatus 110 for the frequency to become unavailable to the radio communications apparatus 110. The calculating unit 1211 notifies the selecting unit 124 of the frequencies indicated by the frequency information and predicted movement distances respectively calculated for the frequencies indicated by the frequency information.

Based on the predicted movement distances notified by the calculating unit 1211, the selecting unit 124 selects a frequency to be used by the radio communications apparatus 110 from among the frequencies notified by the calculating unit 1211. For example, the selecting unit 124 preferentially selects a frequency for which the predicted movement distance notified by the calculating unit 1211 is relatively long among the frequencies notified by the calculating unit 1211.

Thus, the communications apparatus 110 enables the radio communications apparatus 110 to set a frequency for which the predicted movement distance of the radio communications apparatus 110 to become unavailable is relatively long among the frequencies available to the radio communications apparatus 110 at the position of the radio communications apparatus 110. This results in reduced frequency switching at the communications apparatus 110.

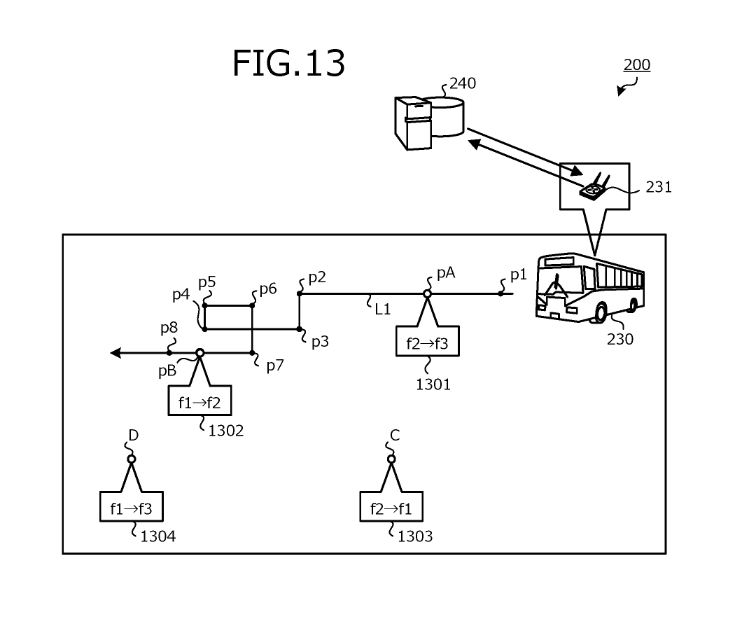

FIG. 13 is a diagram of an application example of the communications system according to the second embodiment. In FIG. 13, parts identical to those depicted in FIG. 2 are designated by the same reference letters or numerals used in FIG. 2 and will not again be described. Switching histories 1301 to 1304 depicted in FIG. 13 are histories that respectively indicate a position where frequency switching occurred by the access point 231 in the past and the frequencies before and after the switching. For example, the switching history 1301 indicates that switching from frequency f2 to frequency f3 occurred at the boundary point pA in the past. The access point 231 obtains the switching histories 1301 and 1302 corresponding to positions on the predicted route L1 of the access point 231, among the switching histories 1301 to 1304.

For example, when the access point 231 is located at the passage point p1, the frequencies f1 and f2 are assumed to be available to the access point 231. If the access point 231 sets the frequency f2 at the passage point p1, the frequency f2 becomes unavailable at the boundary point pA and consequently, the access point 231 has to perform frequency switching. On the other hand, if the access point 231 sets the frequency f1 at the passage point p1, the frequency f1 is available until the boundary point pB and consequently, the access point 231 need not perform frequency switching until the boundary point pB.

Accordingly, the WS database server 240 causes the access point 231 to set the frequency f1 for which the predicted time for the frequency to become unavailable is longer among the frequencies f1 and f2 available to the access point 231 at the passage point p1. This enables a reduction of the frequency switching by the access point 231.

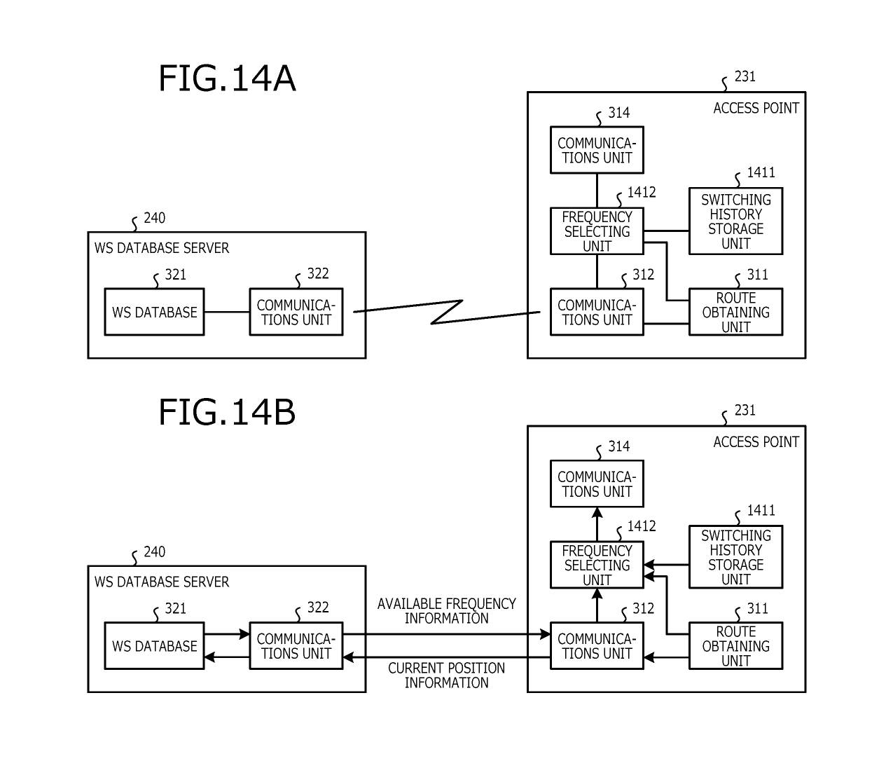

FIG. 14A is a diagram of an example of configuration of the communications system depicted in FIG. 13. FIG. 14B is a diagram of an example of signal flow in the communications system depicted in FIG. 14A. In FIGS. 14A and 14B, parts identical to those depicted in FIGS. 3A and 3B are designated by the same reference letters or numerals used in FIGS. 3A and 3B and will not again be described.

As depicted in FIGS. 14A and 14B, the access point 231 includes for example the route obtaining unit 311, the communications unit 312, a switching history storage unit 1411, a frequency selecting unit 1412, and the communications unit 314. The route obtaining unit 311 obtains current position information indicating the current position of the access point 231. The route obtaining unit 311 outputs the obtained current position information to the communications unit 312. The route obtaining unit 311 obtains predicted route information (see, for example, FIG. 5) of the access point 231. The route obtaining unit 311 then outputs the obtained predicted route information to the frequency selecting unit 1412.

The communications unit 312 transmits to the WS database server 240, the current position information output from the route obtaining unit 311. The communications unit 312 receives available frequency information transmitted from the WS database server 240. The communications unit then outputs the received available frequency information to the frequency selecting unit 1412.

The switching history storage unit 1411 stores history information of the switching of frequencies used for radio communication by the access point 231. The frequency selecting unit 1412 selects a frequency to be used by the access point 231, based on the predicted route information output from the route obtaining unit 311, the history information stored in the switching history storage unit 1411, and the available frequency information output from the communications unit 312. The frequency selecting unit 1412 then sets the selected frequency as a frequency to be used for radio communication by the communications unit 314. The communications unit 314 performs radio communication using the frequencies set by the frequency selecting unit 1412.

The obtaining unit 111 depicted in FIGS. 12A and 12B can be realized, for example, by the route obtaining unit 311. The transmitting unit 112 and the receiving unit 113 depicted in FIGS. 12A and 12B can be realized, for example, by the communications unit 312. The calculating unit 1211 depicted in FIGS. 12A and 12B can be realized, for example, by the frequency selecting unit 1412. The communications unit 114 depicted in FIGS. 12A and 12B can be realized, for example, by the communications unit 314.

As depicted in FIGS. 14A and 14B, the WS database server 240 includes the communications unit 322 and the WS database 321. The communications unit 322 receives current position information transmitted from the access point 231. The communications unit 322 then outputs the received current position information to the WS database 321. The communications unit 322 transmits to the access point 231, available frequency information output from the WS database 321.

The WS database 321 specifies in the stored correspondence information, frequencies corresponding to a position indicated by the current position information output from the access point 231, to output to the communications unit 322, available frequency information indicating the specified frequencies.

The receiving unit 121 and the transmitting unit 125 depicted in FIGS. 12A and 12B can be realized for example by the communications unit 322. The specifying unit 1221 and the obtaining unit 122 depicted in FIGS. 12A and 12B can be realized for example by the WS database 321.

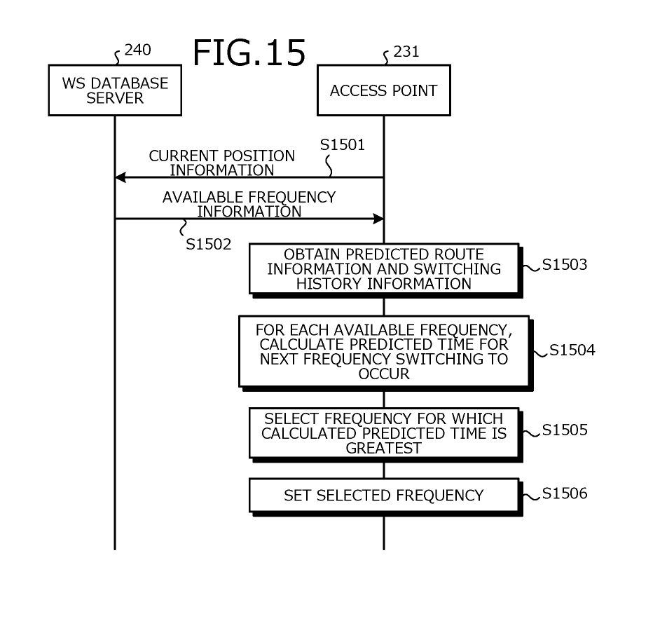

FIG. 15 is a sequence diagram of an operation example of the communications system depicted in FIG. 13. The communications system 200 depicted in FIG. 13 operates, for example, as indicated by the steps depicted in FIG. 15. First, the access point 231 transmits current position information indicating the current position of the access point 231 to the WS database server 240 (step S1501).

The WS database server 240 then transmits to the access point 231, available frequency information indicating frequencies available to the access point 231 at the position indicated by the current position information transmitted at step S1501 (step S1502).

The access point 231 obtains predicted route information and switching history information of the access point 231 (step S1503). The access point 231 calculates for each available frequency indicated by the available frequency information transmitted at step S1502, a predicted time for frequency switching to occur by the access point 231 (step S1504).

The access point 231 then selects from among the available frequencies indicated by the available frequency information transmitted at step S1502, a frequency for which the predicted time calculated at step S1504 is longest (step S1505). The access point 231 sets the frequency selected at step S1505 as the frequency for use in radio communication (step S1506), and terminates a series of operations.

The above operations enable the access point 231 to set a frequency for which the predicted time of becoming unavailable is longer among frequencies available to the access point 231 at the current position of the access point 231. As a result, frequency switching by the access point 231 can be reduced.

The operations depicted in FIG. 15 are executed, for example, at the time of powering on of the access point 231. The timing at which the operations depicted in FIG. 15 are executed is not limited hereto. For example, the operations depicted in FIG. 15 may be executed every time the frequency being used by the access point 231 becomes unavailable as a result of movement of the access point 231. This can reduce frequency switching, not only at the time of powering on.

The operations depicted in FIG. 15 may be executed every time the predicted route L1 of the access point 231 changes. The operations depicted in FIG. 15 may be executed periodically. This enables the frequency switching by the access point 231 to be reduced, irrespective of a change in the predicted route L1 of the access point 231 due to rerouting, etc.

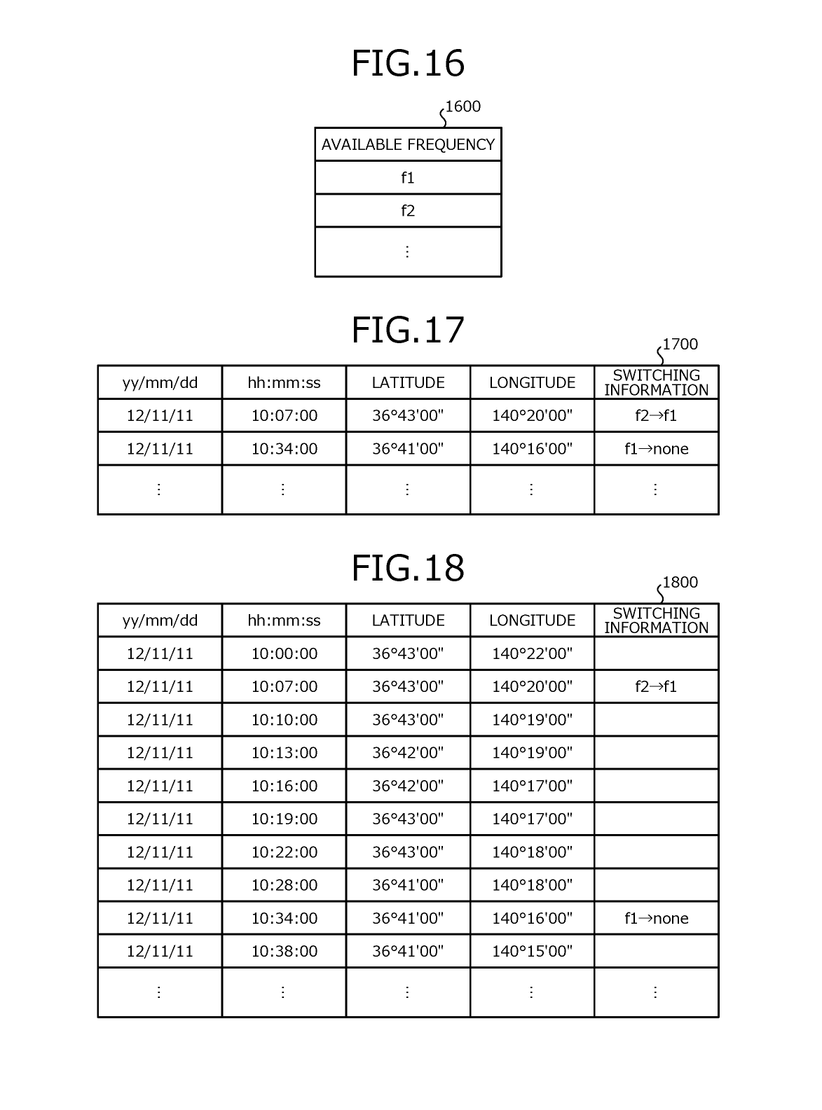

FIG. 16 is a diagram of an example of available frequency information. The WS database server 240 transmits, for example, available frequency information 1600 depicted in FIG. 16 to the access point 231. In the available frequency information 1600 are arranged frequencies (f1, f2, . . . ) available to the access point 231 at the current position of the access point 231. The access point 231 selects from among frequencies arranged in the available frequency information 1600, a frequency for use in radio communications.

FIG. 17 is a diagram of an example of switching history information. The switching history storage unit 1411 of the access point 231 stores, for example, switching history information 1700 depicted in FIG. 17. In the switching history information 1700, date (yy/mm/dd), time (hh:mm:ss), latitude, longitude, and frequencies before and after switching are correlated with each position where frequency switching occurred by the access point 231 in the past. “none” indicated for the frequencies before and after switching means that no frequencies were available to the access point 231.

For example, a first record of the switching history information 1700 indicates that the access point 231 passed the passage point p1 at 10:07:00 on Dec. 11, 2011, latitude (36 [degrees], 43′00″), and longitude (140 [degrees], 22′00″). The first record of the switching history information 1700 indicates that switching from frequency f2 to frequency f1 occurred when the access point 231 passed the passage point p1.

FIG. 18 is a diagram of an example of frequency switching history on the predicted route depicted in FIG. 13. The frequency selecting unit 1412 of the access point 231 creates a table 1800 depicted in FIG. 18 through operations based on the predicted route information (see, for example, FIG. 5) output from the route obtaining unit 311 and based on the switching history information (see, for example, FIG. 17) stored in the switching history storage unit 1411.

In the table 1800, switching information is correlated with passage points where frequency switching occurred by the access point 231 in the past, among passage points of the access point 231 based on the predicted route indicated by the predicted route information. The switching information indicates frequencies before and after switching at a corresponding passage point.

For each of the specified frequencies f1 and f2, the frequency selecting unit 1412 calculates based on the table 1800, a predicted time for the next frequency switching to occur by the access point 231 if the specified frequency is set in the access point 231.

In the example depicted in FIG. 18, if the frequency f1 is set in the access point 231, the frequency f1 remains available until 10:34:00 of the same date and consequently, the predicted time for frequency switching to occur by the access point 231 is 34 min. If the frequency f2 is set in the access point 231, the frequency f2 is available until 10:07:00 of the same date and consequently, the predicted time for frequency switching to occur by the access point 231 is 7 min.

Accordingly, the frequency selecting unit 1412 selects as the frequency to be used by the access point 231, the frequency f1 having for which the predicted time for frequency switching to occur by the access point 231 is longest among the specified frequencies f1 and f2.

Although the example depicted in FIG. 13 has been described in a case where the frequency to be used is selected based on the predicted time for frequency switching to occur, configuration may be such that the frequency to be used is selected based on the predicted movement distance of the access point 231 for frequency switching to occur.

For example, for each of the specified available frequencies, the frequency selecting unit 1412 calculates a predicted movement distance of the access point 231 for the next frequency switching to occur if the specified available frequency is set in the communications unit 314. The frequency selecting unit 1412 then selects the available frequency for which the calculated predicted movement distance is greatest among the specified available frequencies, as the frequency to be used by the access point 231.

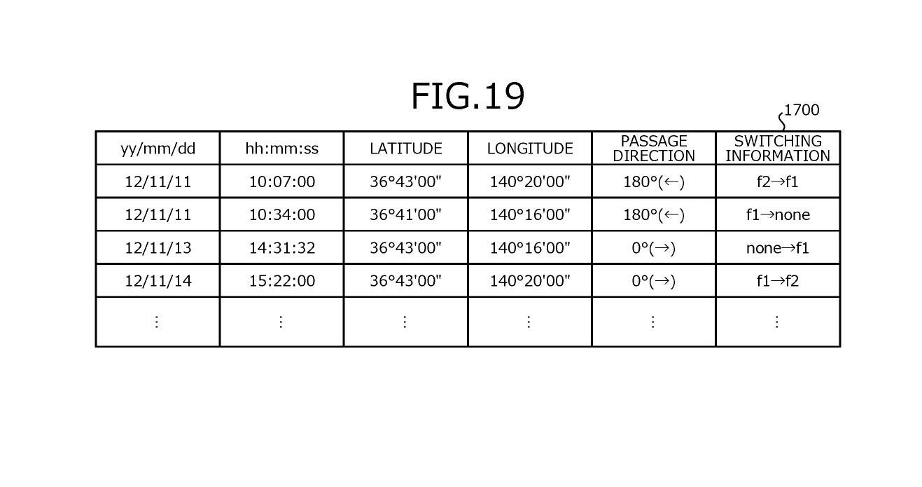

FIG. 19 is a diagram of another example of the switching history information. In FIG. 19, parts identical to those depicted in FIG. 17 are designated by the same reference letters or numerals used in FIG. 17 and description thereof will be omitted. The switching history storage unit 1411 of the access point 231 may store, for example, the switching history information 1700 depicted in FIG. 19. In the switching history information 1700 depicted in FIG. 19, passage direction in addition to the items depicted in FIG. 17 is correlated with each position where frequency switching occurred by the access point 231 in the past.

The passage direction of the switching history information 1700 depicted in FIG. 19 is indicated, for example, by an angle relative to a predetermined direction (e.g., right direction in FIG. 13).

For example, a first record of the switching history information 1700 indicates that at 10:07:00 on Dec. 11, 2011, the access point 231 passed a passage point p1 in the direction of 180 degrees (e.g., left direction of FIG. 13) relative to the predetermined direction.

In this manner, the switching history information 1700 may include a history of frequency switching by the access point 231, corresponding to combinations of positions on the predicted route L1 and directions in which the access point 231 passed through the positions on the predicted route L1. This enables the switching history (see, e.g., FIG. 18) of frequencies on the predicted route L1 of the access point 231 to be more accurately determined.

In this manner, according to the second embodiment, the radio communications apparatus can set a frequency for which the predicted time for the frequency to become unavailable is relatively long among the frequencies available to the radio communications apparatus at the position of the radio communications apparatus. Alternatively, the radio communications apparatus can set a frequency for which the predicted movement distance for the frequency to become unavailable is longer among frequencies available to the radio communications apparatus at the position of the radio communications apparatus. As a result, frequency switching by the radio communications apparatus can be reduced.

Parts of a third embodiment differing from the first embodiment will be described.

The communications system 100 according to the third embodiment is similar to the communications system 100 depicted in FIGS. 1A and 1B, for example. It is to be noted, however, that for each of the specified frequencies, the calculating unit 123 of the communications control apparatus 120 calculates for the radio communications apparatus 110, a predicted frequency switching count of frequency switching that occurs on the predicted route of the radio communications apparatus 110 if the specified frequency is set in the radio communications apparatus 110. The calculating unit 123 notifies the selecting unit 124 of the specified frequencies and the predicted count calculated for each specified frequency.

Based on the predicted count notified by the calculating unit 123, the selecting unit 124 selects a frequency to be used by the radio communications apparatus 110 from among frequencies notified by the calculating unit 123. For example, the selecting unit 124 preferentially selects a frequency for which the predicted count notified by the calculating unit 123 is lower among the frequencies notified by the calculating unit 123.

The communications system 100 according to the third embodiment enables the radio communications apparatus 110 to set a frequency for which less frequency switching occurs on the predicted route, among the frequencies available at the position of the radio communications apparatus 110. As a result, frequency switching by the radio communications apparatus 110 can be reduced.

Although description has been given of a configuration where the frequency of the radio communications apparatus 110 is selected at the communications control apparatus 120, configuration may be such that as in the second embodiment, the frequency of the radio communications apparatus 110 is selected at the radio communications apparatus 110. For example, for each of the specified frequencies, the calculating unit 1211 depicted in FIGS. 12A and 12B calculates a predicted frequency switching count for the predicted route of the radio communications apparatus 110 if the specified frequency is set in the radio communications apparatus 110. The calculating unit 1211 then notifies the selecting unit 124 of the specified frequencies and the predicted count calculated for each of the specified frequencies. Based on the predicted count notified by the calculating unit 1211, the selecting unit 124 selects a frequency to be used by the radio communications apparatus 110 from among the frequencies notified by the calculating unit 1211.

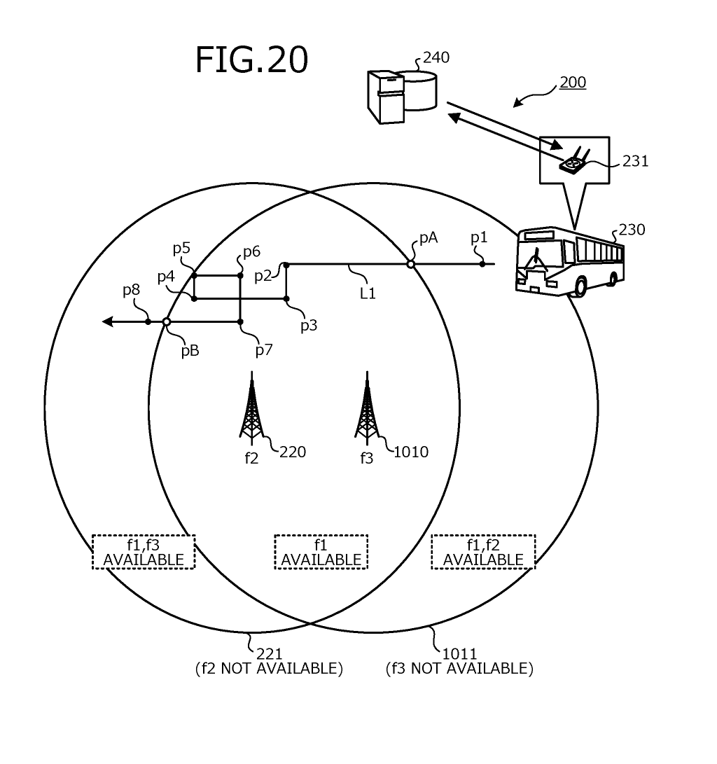

FIG. 20 is a diagram of an application example of the communications system according to the third embodiment. In FIG. 20, parts identical to those depicted in FIGS. 2 and 10 are designated by the same reference letters or numerals used in FIGS. 2 and 10 and will not again be described. The example depicted in FIG. 20 assumes that the frequencies available for radio communication by the access point 231 are frequencies f1 to f3. The frequencies f1 to f3 are frequencies differing from one another.

In the example depicted in FIG. 20, the passage point p1 is not in the area 221 but is in the area 1011. Thus, the frequencies f1 and f2 are available to the access point 231 at the passage point p1. The passage points p2 to p7 are in the areas 221 and 1011. Thus, the frequency f1 is available to the access point 231 at the passage points p2 to p7. The passage point p8 is not in the area 1011 but is in the area 221. Therefore, the frequencies f1 and f3 are available to the access point 231 at the passage point p8.

The boundary point pA is a position on the predicted route L1 where the access point 231 enters the area 221. The boundary point pB is a position on the predicted route L1 where the access point 231 leaves the 1011.

For example, if the access point 231 is located at the passage point p1, frequencies available to the access point 231 are the frequencies f1 and f2. If the access point 231 sets the frequency f1 at the passage point p1, the predicted frequency switching count for the access point 231 on the predicted route L1 is 0. If the access point 231 sets the frequency f2 at the passage point p1, the predicted frequency switching count is 1 for the frequency switch at the boundary point pA.

The WS database server 240 thus causes the access point 231 to set the frequency f1 for which the predicted frequency switching count is smallest among the frequencies f1 to f3 available to the access point 231 at the passage point p1. As a result, frequency switching by the access point 231 can be reduced.

The access point 231 and the WS database server 240 depicted in FIG. 20 are similar to those depicted in FIGS. 3A and 3B, for example. However, for each of the specified available frequencies, the frequency selecting 323 of the WS database server 240 calculates a predicted frequency switching count for the access point 231 on the predicted route L in a case of the specified available frequency being set in the access point 231. The frequency selecting unit 323 then selects, as the frequency to be used by the access point 231, a frequency for which the calculated predicted count is smallest among the available frequencies of the access point 231.

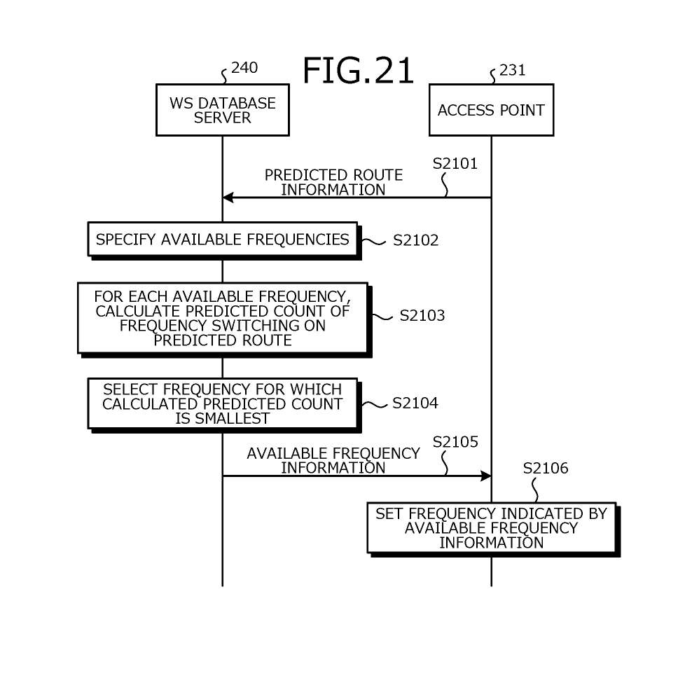

FIG. 21 is a sequence diagram of an operation example of the communications system depicted in FIG. 20. The communications system 200 depicted in FIG. 20 operates, for example, as indicated by the steps depicted in FIG. 21. First, the access point 231 transmits predicted route information of the access point 231 to the WS database server 240 (step S2101).

The WS database server 240 then specifies available frequencies corresponding to the current position of the access point 231, based on the predicted route information transmitted at step S2101 and based on the correspondence information (step S2102). For each of the available frequencies specified at step S2102, the WS database server 240 then calculates a predicted count of frequency switching by the access point 230 if the WS database server 240 causes the access point 231 to set the available frequency (step S2103).

The WS database server 240 selects from among the available frequencies specified at step S2102, the frequency for which the predicted count calculated at step S2103 is smallest (step S2104). The WS database server 240 transmits available frequency information indicating the frequency selected at step S2104 to the access point 231 (step S2105).

The access point 231 sets the frequency indicated by the available frequency information transmitted at step S2105, as a frequency to be used for radio communication by the access point 231 (step S2106), and terminates a series of the operations.

The above operations enable the access point 231 to set a frequency for which the predicted count of frequency switching on the predicted route L1 is smallest among frequencies available to the access point 231 at the current position of the access point 231. As a result, frequency switching by the access point 231 can be reduced.

The operations depicted in FIG. 21 are executed, for example, at the time of powering on of the access point 231. Nonetheless, the timing at which the operations depicted in FIG. 21 are executed are not limited hereto.

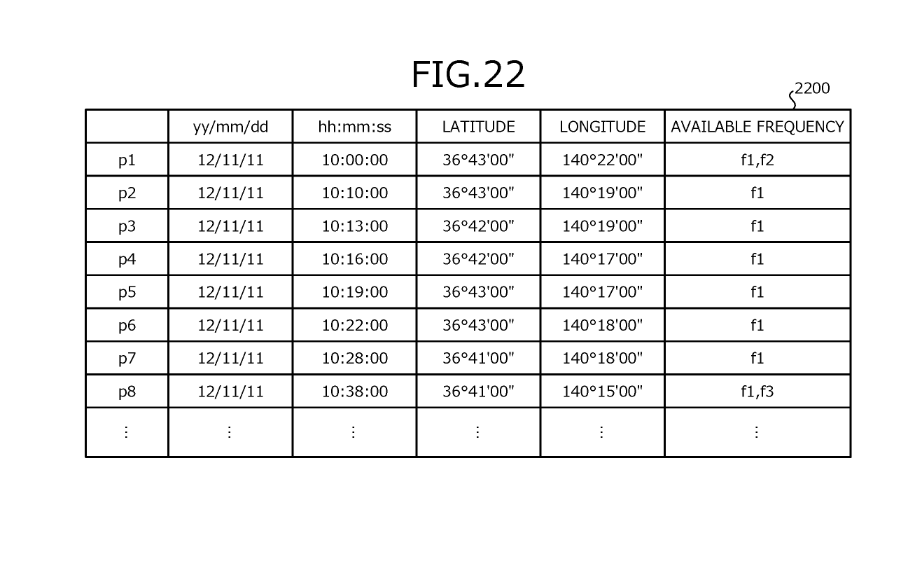

FIG. 22 is a diagram of an example of frequencies available at positions on the predicted route depicted in FIG. 20. The frequency selecting unit 323 of the WS database server 240 depicted in FIG. 20 creates a table 2200 depicted in FIG. 22 through calculations based on predicted route information output from the communications unit 322 and based on correspondence information stored in the WS database 321.

In the table 2200, similar to the table 700 depicted in FIG. 7, frequencies available to the access point 231 are correlated with each passage point of the access point 231 based on the predicted route indicated by the predicted route information.

In the example depicted in FIG. 22, if the frequency f1 is set in the access point 231, the predicted route L1 has no history that the frequency f1 became unavailable and consequently, the predicted frequency switching count on the predicted route L1 is 0. If the frequency f2 is set in the access point 231, the predicted route L1 has a history that the frequency f2 became unavailable at the passage point p2 and consequently, the predicted frequency switching count on the predicted route L1 is 1.

The frequency selecting unit 323, therefore, selects, as the frequency used by the access point 231, the frequency f1 for which the predicted frequency switching count on the predicted route L1 is smallest among the specified frequencies f1 and f2.

In this manner, according to the third embodiment, the radio communications apparatus can set a frequency for which the predicted frequency switching count for the predicted route is smallest among frequencies available to the radio communications apparatus at the position of the radio communications apparatus. As a result, frequency switching by the radio communications apparatus can be reduced.

Parts of a fourth embodiment differing from the second embodiment will be described.

The communications system 100 according to the fourth embodiment is similar to the communications system 100 depicted in FIGS. 12A and 12B for example. However, the obtaining unit 111 of the radio communications apparatus 110 obtains history information indicating history of switching of the frequencies used for radio communication by the radio communications apparatus 110 in a predetermined range that includes the position of the radio communications apparatus 110. The obtaining unit 111 outputs the obtained history information to the calculating unit 1211.

For each of the frequencies indicated by the frequency information output from the receiving unit 113, the calculating unit 1211 calculates a count of switching from the frequency to another frequency occurring in the predetermined range, based on the history information output from the obtaining unit 111. The calculating unit 1211 then notifies the selecting unit 124 of the frequencies indicated by the frequency information and the count calculated for each frequency indicated by the frequency information.

Based on the counts notified by the calculating unit 1211, the selecting unit 124 selects a frequency to be used by the radio communications apparatus 110 among the frequencies notified by the calculating unit 1211. The selecting unit 124 then notifies the communications unit 114 of the selected frequency.

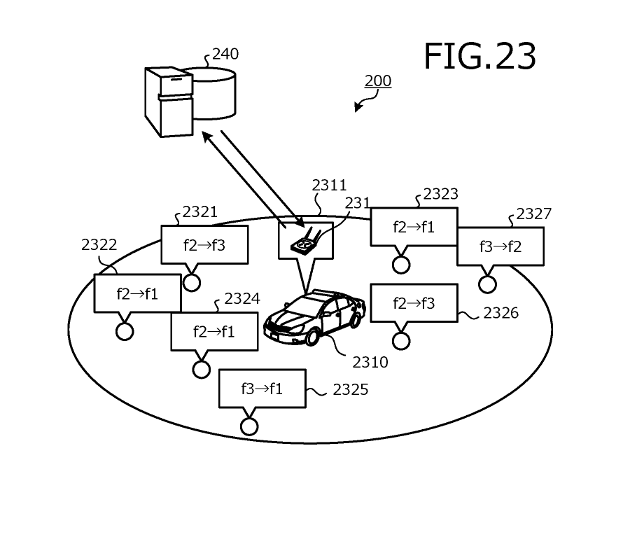

FIG. 23 is a diagram of an application example of the communications system according to the fourth embodiment. In FIG. 23, parts identical to those depicted in FIG. 2 are designated by the same reference letters or numerals used in FIG. 2 and will not again be described. The communications system 100 according to the fourth embodiment is applicable to the communications system 200 depicted in FIG. 23, for example. A vehicle 2310 depicted in FIG. 23 is equipped with the access point 231. The radio communications apparatus 110 according to the fourth embodiment is applicable to the access point 231, for example. The communications control apparatus 120 according to the fourth embodiment is applicable to the WS database server 240, for example.

A predetermined range 2311 is a predetermined range that includes the position of the access point 231. For example, the predetermined range 2311 is a range encompassed by a circle of a predetermined radius around the access point 231. The predetermined radius is determined, for example, by the travelling speed of the access point 231. For example, if the travelling speed (e.g., average travelling speed) of the access point 231 is v [km/h], the predetermined range 2311 is a range encompassed by a circle with a radius a·v (a is a constant) around the access point 231.

An example is assumed in which the travelling speed of the access point 231 is 30 [km/h] with the constant a=1. In this case, the predetermined range 2311 is a circle with a radius of 30 [km] around the current position of the access point 231.

Switching histories 2321 to 2327 depicted in FIG. 23 are switching histories corresponding to positions in the predetermined range 2311, among histories each indicating a position where frequency switching occurred by the access point 231 in the past and frequencies before and after the frequency switching. The access point 231 obtains the switching histories 2321 to 2327. For example, the access point 231 extracts from stored histories, histories in which the distances between the positions corresponding to the histories and current position of the access point 231 are not more than the predetermined radius, to thereby obtain the switching histories 2321 to 2327.

An example is assumed in which the frequencies available to the access point 231 at the current position of the access point 231 are the frequencies f1 to f3. For each of the frequencies f1 to f3, the access point 231 calculates the number of histories indicating a history of switching from a given frequency to another frequency, among the switching histories 2321 to 2327.

In the example depicted in FIG. 23, the number of histories indicating a history of switching from the frequency f1 to another frequency, among the switching histories 2321 to 2327 is the minimum (0). Thus, the access point 231 sets the frequency f1 among the frequencies f1 to f3 available to the access point 231 at the current position of the access point 231. As a result, frequency switching by the access point 231 can be reduced.

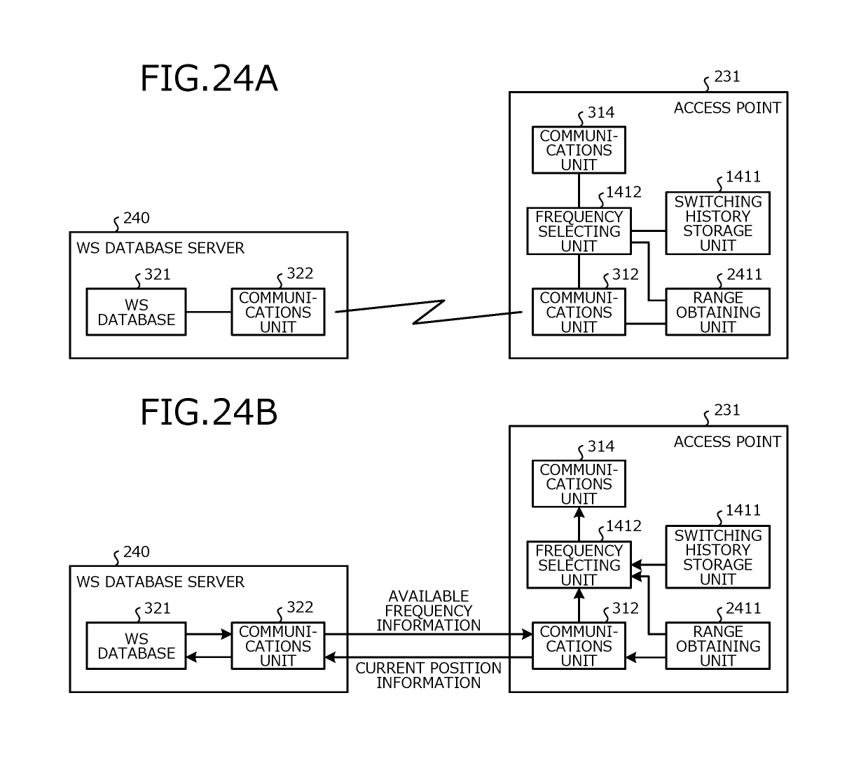

FIG. 24A is a diagram of an example of configuration of the communications system depicted in FIG. 13. FIG. 24B is a diagram of an example of signal flow in the communications system depicted in FIG. 24A. In FIGS. 24A and 24B, parts identical to those depicted in FIGS. 14A and 14B are designated by the same reference letters or numerals used in FIGS. 14A and 14B and will not again be described.

As depicted in FIGS. 24A and 24B, the access point 231 includes for example a range obtaining unit 2411 in place of the route obtaining unit 311. The range obtaining unit 2411 obtains current position information indicating the current position of the access point 231. The range obtaining unit 2411 outputs the obtained current position information to the communications unit 312. The range obtaining unit 2411 obtains predicted range information for the access point 231. The predicted range information is, for example, information indicating the range 2311 depicted in FIG. 23, for example. The range obtaining unit 2411 then outputs the obtained predicted route information to the frequency selecting unit 1412.

The frequency selecting unit 1412 selects a frequency to be used by the access point 231, based on the predicted range information output from a range obtaining unit 2411, the available frequency information output from the communications unit 312, and the switching history information output from the switching history storage unit 1411.

The obtaining unit 111 according to the fourth embodiment can be realized, for example, by the range obtaining unit 2411.

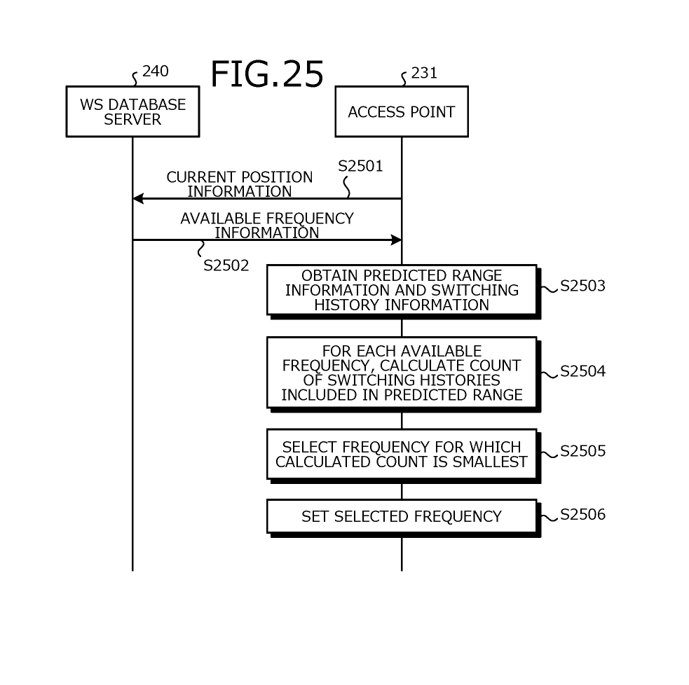

FIG. 25 is a sequence diagram of an operation example of the communications system depicted in FIG. 23. The communications system 200 depicted in FIG. 23 operates, for example, as indicated by the steps depicted in FIG. 25. First, the access point 231 transmits current position information indicating the current position of the access point 231 to the WS database server 240 (step S2501).

The WS database server 240 then transmits to the access point 231, available frequency information indicating frequencies available to the access point 231 at the position indicated by the current position information transmitted at step S2501 (step S2502).

The access point 231 obtains predicted range information and switching history information of the access point 231 (step S2503). The access point 231 calculates for each available frequency indicated by the available frequency information transmitted at step S2502 and based on switching history information, a count of switching histories included in the predicted range indicated by the predicted range information (step S2504).

The access point 231 then selects from among the available frequencies indicated by the available frequency information transmitted at step S2502, a frequency for which the calculated count is smallest (step S2505). The access point 231 sets the frequency selected at step S2505 as the frequency for use in radio communication (step S2506), and terminates a series of operations.

The above operations enable the access point 231 to set a frequency for which the count of switching histories included in a predetermined range are few among the frequencies available to the access point 231 at the current position of the access point 231. As a result, frequency switching by the access point 231 can be reduced.

The operations depicted in FIG. 25 are executed, for example, at the time of powering on of the access point 231. The timing at which the operations depicted in FIG. 25 are executed is not limited hereto.

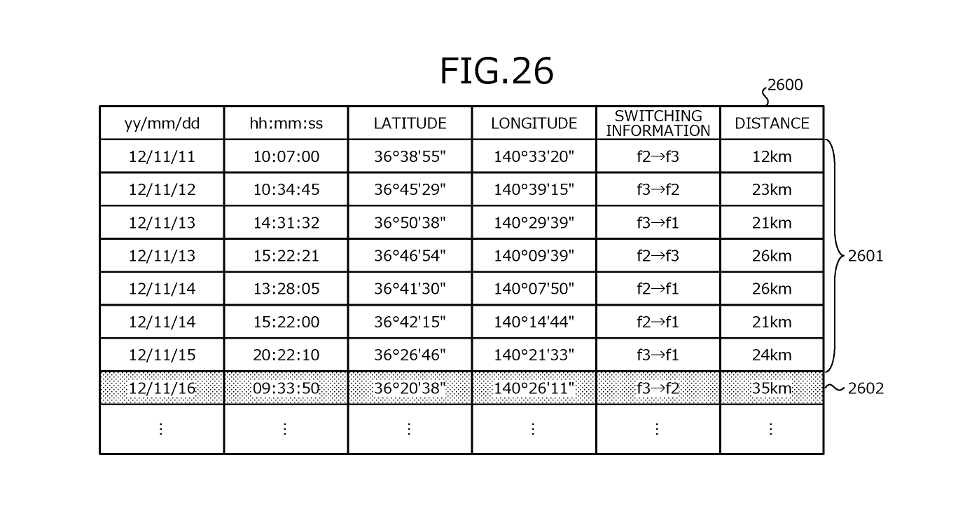

FIG. 26 is a diagram of an example of the distance between the history position and the current position. The frequency selecting unit 1412 of the access point 231 creates a table 2600 depicted in FIG. 26, for example, based on the predicted range information output from the range obtaining unit 2411 and based on the switching history information stored in the switching history storage unit 1411. In the table 2600, the distance between the history position (latitude and longitude) and the current position of the access point 231 is correlated with each record of the switching history information 1700 depicted in FIG. 17, for example.

An example is assumed in which the predetermined range 2311 depicted in FIG. 23 is a circle with a radius of 30 [km] around the current position of the access point 231. In this case, a record 2602 of the table 2600 has a distance of 35 [km] and therefore, is out of the predetermined range 2311. On the contrary, the access point 231 selects a frequency based on a record 2601 of the table 2600, corresponding to positions in the predetermined range 2311.

In the example depicted in FIG. 26, the record 2601 has no history of switching from frequency f1 to another frequency. The record 2601 has four histories of switching from frequency f2 to another frequency. The record 2601 has three histories of switching from frequency f3 to another frequency.

The frequency selecting unit 1412 thus selects, as the frequency to be used by the access point 231, the frequency f1 having the least number of histories in the predetermined range 2311 among the frequencies f1 to f3.

Although a case has been described where the predetermined range 2311 is a range encompassed by a circle of a predetermined radius around the access point 231, the predetermined range 2311 is not limited hereto. For example, the range may be determined based on the direction of travel of the access point 231.

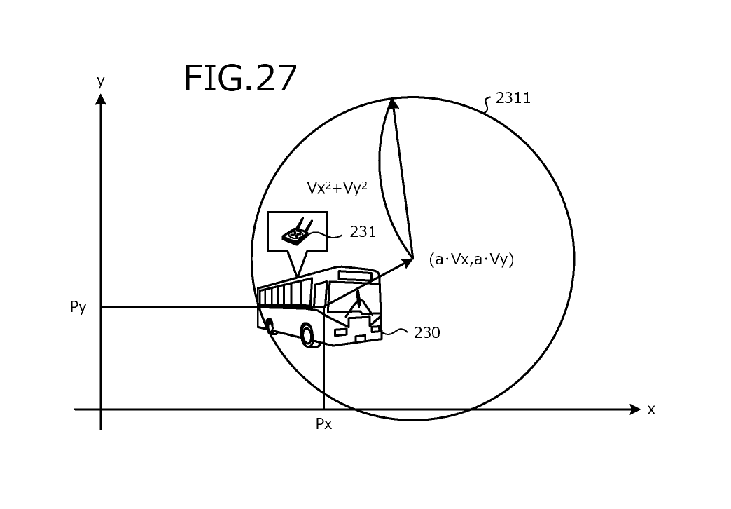

FIG. 27 is a diagram of another example of the predetermined range. In FIG. 27, Vx represents the average travelling speed of the access point 231 in an X-axis direction, while Vy represents the average travelling speed of the access point 231 in a Y-axis direction. (Px, Py) represents the current position of the access point 231. In this case, the predetermined range 2311 can be a range expressed by equation (1). In equation (1), a is a real number value ranging in the range of 0≦a<1.

(X−Px−a·Vx)²+(Y−Py−a·Vy)²=Vx²+Vy² (1)

As a result, the predetermined range 2311 can be a circle around a position offset in the direction of travel of the access point 231, from the current position of the access point 231. This enables the frequency to be selected based on the history information for a position having a high possibility of being a destination of the access point 231. Thus, a frequency tending to reduce frequency switching by the radio communications apparatus can be selected.

In this manner, according to the fourth embodiment, the radio communications apparatus can set a frequency having a fewer number of histories of switching from a given frequency to another frequency in a predetermined range that includes the position of the radio communications apparatus, among frequencies available to the radio communications apparatus. As a result, frequency switching by the radio communications apparatus can be reduced.

For example, the frequency can be selected by calculating a predicted movement range of the access point 231 from the travelling speed, etc., of the access point 231 and counting the number of histories of frequency switching that occurred in the calculated predicted movement range. Thus, a frequency having a high possibility of reducing frequency switching by the radio communications apparatus can be selected.

The access point 231 may select a frequency based on the count of switching from a given frequency to another frequency, weighted according to the distance from the access point 231 to the position where the corresponding switching occurred. For example, a history weight increases as the distance decreases from the access point 231 to the position where the corresponding switching occurred. This enables a frequency to be selected increasing the history weight for a position having a high possibility of being a destination of the access point 231. Thus, a frequency can be selected that tends to reduce frequency switching by the radio communications apparatus.

A history weight w(r) can be calculated using a monotonically decreasing function expressed in equation (2) below. In equation (2), R designates the radius of the predetermined range 2311. r designates the distance from the access point 231 of the position where a switching corresponding to a history occurred.

w(r)=1−r/R (2)

As a result, the history weight can be increased as the distance of the position where a corresponding switching occurred from the access point 231 becomes smaller. The history weight can be 0 at the boundary of the predetermined range 2311.

If rf(i) denotes a distance from the access point 231 to an i-th position where a switching from a frequency f to another frequency occurred, the count of switching from a frequency f to another frequency can be calculated using, for example, equation (3) below.

Nf=Σᵢ₌₀^{nf}w{rf(i)} (3)

In equation (3) above, of denotes the number of positions where a switching of a frequency f occurred in the predetermined range 2311. In the example depicted in FIG. 26, for example, a count Nf (Nf1) of switching of frequency f1 is 0. A count Nf (Nf2) of switching of frequency f2 is as expressed by equation (4) below. A count Nf (Nf3) of switching of frequency f3 is as expressed by equation (5) below.

$$\begin{matrix}Nf 2 = ( 1 - \frac{12}{30} ) + ( 1 - \frac{26}{30} ) + ( 1 - \frac{26}{30} ) + ( 1 - \frac{21}{30} ) = 1.1666 & ( 4 ) \\ Nf 3 = ( 1 - \frac{23}{30} ) + ( 1 - \frac{21}{30} ) + ( 1 - \frac{24}{30} ) = 0.7333 & ( 5 )\end{matrix}$$

Parts of a fifth embodiment differing from the first embodiment will be described.

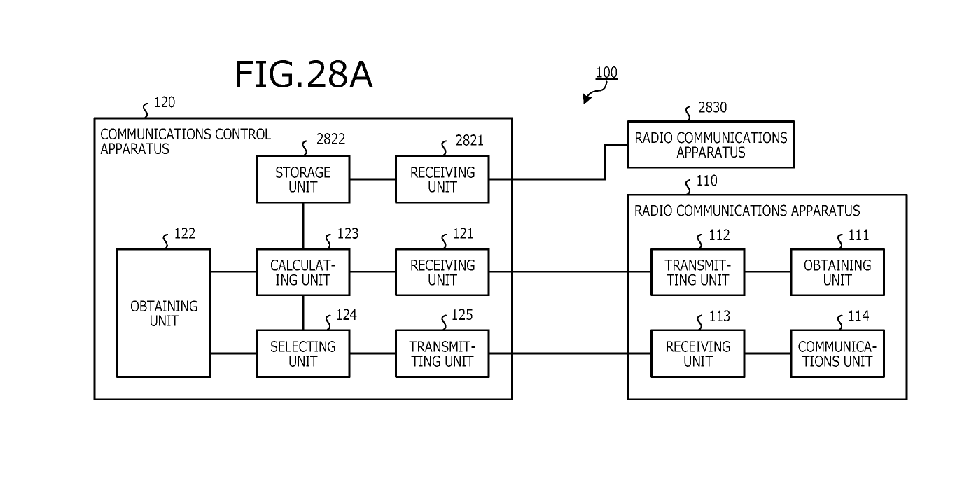

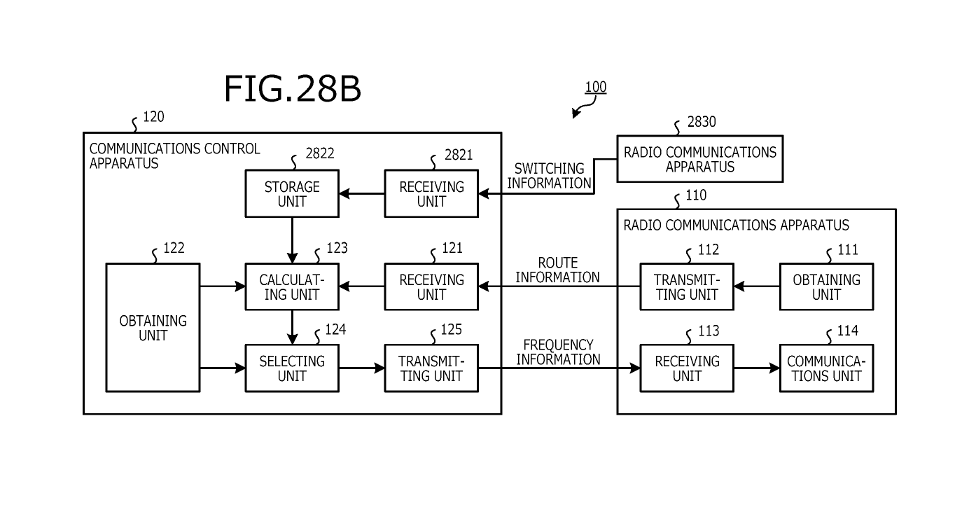

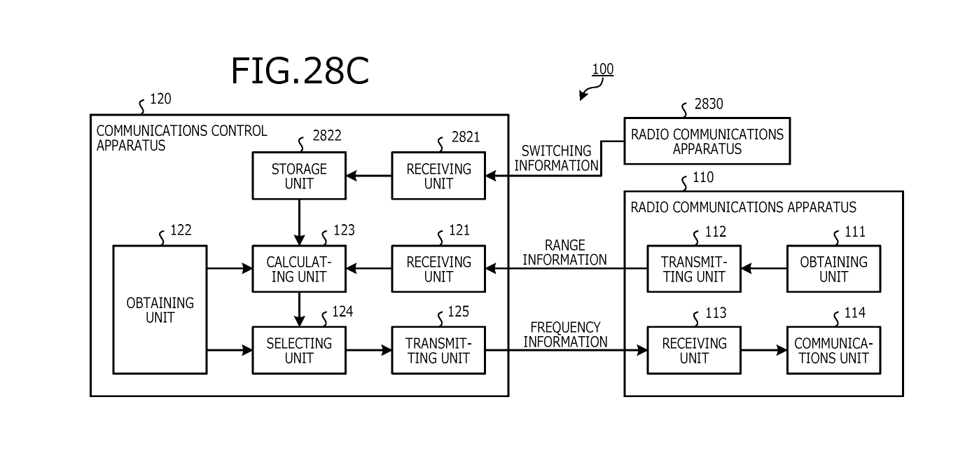

FIG. 28A is a diagram of an example of the communications system according to a fifth embodiment. FIG. 28B is a diagram of an example of signal flow in the communications system depicted in FIG. 28A. In FIGS. 28A and 28B, parts identical to those depicted in FIGS. 1A and 1B are designated by the same reference letters or numerals used in FIGS. 1A and 1B and will not again be described.

Similar to the radio communications apparatus 110, a radio communications apparatus 2830 selects a frequency available to the radio communications apparatus 2830 at the position of the radio communications apparatus 2830, to perform radio communications. Information indicating correspondence between positions and available frequencies is common to the radio communications apparatus 110 and the radio communications apparatus 2830. When frequency switching occurs, the radio communications apparatus 2830 transmits switching information to the communications control apparatus 120. The switching information includes, for example, information indicating the time when and the position where the frequency switching occurred and the frequencies before and after switching. Plural radio communications apparatuses 2830 may be present.

The communications control apparatus 120 according to the fifth embodiment includes a receiving unit 2821 and a storage unit 2822, in addition to the configuration depicted in FIGS. 1A and 1B. The receiving unit 2821 receives switching information transmitted from the radio communications apparatus 2830. The receiving unit 2821 then causes the storage unit 2822 to store the received switching information.

For each of the specified frequencies, the calculating unit 123 calculates a count of switching from a given frequency to another frequency on a predicted route indicated by the route information output from the receiving unit 121, based on the switching information stored in the storage unit 2822. The calculating unit 123 notifies the selecting unit 124 of the specified frequencies and the count calculated for each of the specified frequencies.

Alternatively, for each of the specified frequencies, the calculating unit 123 calculates the time or distance for switching to occur from a given frequency to another frequency on a predicted route indicated by the route information output from the receiving unit 121, based on the switching information stored in the storage unit 2822. The calculating unit 123 notifies the selecting unit 124 of the specified frequencies and the time or distance calculated for each of the specified frequencies.

Based on the count or the time or distance required for switching notified by the calculating unit 123, the selecting unit 124 selects a frequency to be used by the radio communications apparatus 110 from among the frequencies notified by the calculating unit 123. For example, the selecting unit 124 preferentially selects a frequency for which the count notified by the calculating unit 123 is fewer among the frequencies notified by the calculating unit 123. If the notified information is the time or the distance required for switching, selection is made of a frequency having a longer time or a farthest distance.

The communications system 100 according to the fifth embodiment enables the radio communications apparatus 110 to set a frequency for which the number of times switching to another frequency on the predicted route occurs is fewer or for which the time or distance required for switching is greatest, among the frequencies available to the radio communications apparatus 110 in the position of the radio communications apparatus 110.

FIG. 28C is a diagram of another example of signal flow in the communications system depicted in FIG. 28A. In FIG. 28C, parts identical to those depicted in FIG. 28B are designated by the same reference letters or numerals used in FIG. 28B and description thereof will be omitted. As depicted in FIG. 28C, the obtaining unit 111 of the radio communications apparatus 110 obtains range information indicating a predetermined range including the position of the radio communications apparatus 110. The predetermined range is similar to the predetermined range (predicted movement range) described in the fourth embodiment, for example. The obtaining unit 111 outputs the obtained range information to the transmitting unit 112. The transmitting unit 112 transmits to the communications control apparatus 120, the range information output from the obtaining unit 111.

The receiving unit 121 of the communications control apparatus 120 receives the range information transmitted from the radio communications apparatus 110. The receiving unit 121 outputs the received range information to the calculating unit 123. For each of the specified frequencies, the calculating unit 123 calculates based on the switching information stored in the storage unit 2822, a count of switching from a given frequency to another frequency in the predetermined range indicated by the range information output from the receiving unit 121.

The communications system 100 depicted in FIG. 28C enables the radio communications apparatus 110 to set a frequency having a fewer occurrences of switching to another frequency in the predetermined range, among the frequencies available to the radio communications apparatus 110 at the position of the radio communications apparatus 110. As a result, frequency switching by the radio communications apparatus 110 can be reduced.

Similar to the radio communications apparatus 2830, the radio communications apparatus 110 may also transmit switching information to the communications control apparatus 120 when frequency switching has occurred. The receiving unit 2821 receives switching information transmitted from the radio communications apparatus 2830 and causes the storage unit 2822 to store the received switching information. This enables the radio communications apparatus 110 to set a frequency having fewer occurrences of switching to another frequency by the radio communications apparatus 110 and by the radio communications apparatus 2830.

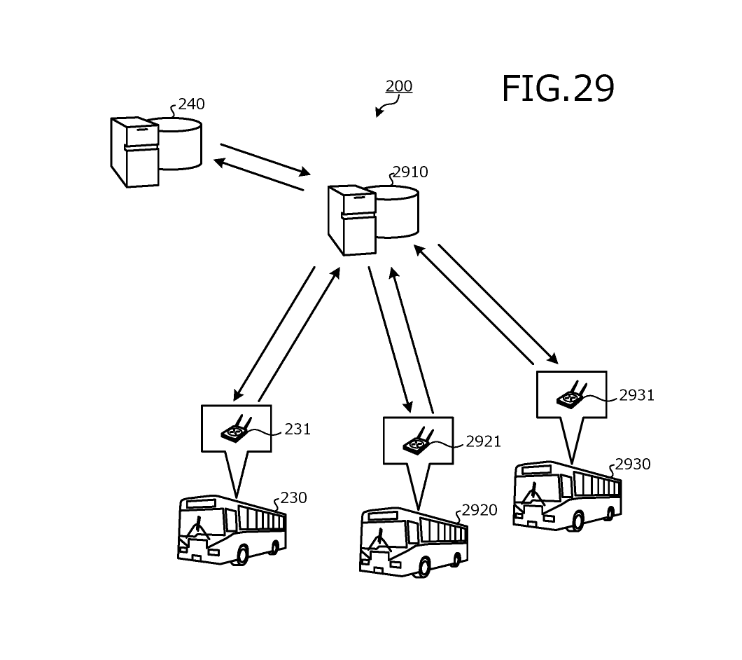

FIG. 29 is a diagram of an application example of the communications system according to the fifth embodiment. In FIG. 29, parts identical to those depicted in FIG. 2 are designated by the same reference letters or numerals used in FIG. 2 and will not again be described. The communications system 100 depicted in FIGS. 1A and 1B is applicable to the communications system 200 depicted in FIG. 29, for example. A bus vehicle 2920 is equipped with an access point 2921. A bus vehicle 2930 is equipped with an access point 2931. The radio communications apparatus 2830 depicted in FIGS. 28A and 28B is applicable to the access points 2921 and 2931, respectively, for example.

When frequency switching occurs, the access points 231, 2921, and 2931 transmit to a switching history database server 2910, switching information indicating the position where the frequency switching has occurred and frequencies before and after the switching. The switching history database server 2910 stores the switching information transmitted from the access points 231, 2921, and 2931.

In this manner, frequency switching information from plural WS devices is aggregated into the switching history database server 2910 so that a frequency to be used by the access point 231 can be selected based on the aggregated switching information. Frequencies used by the access points 2921 and 2931 may also be selected based on the switching information aggregated in the switching history database server 2910.

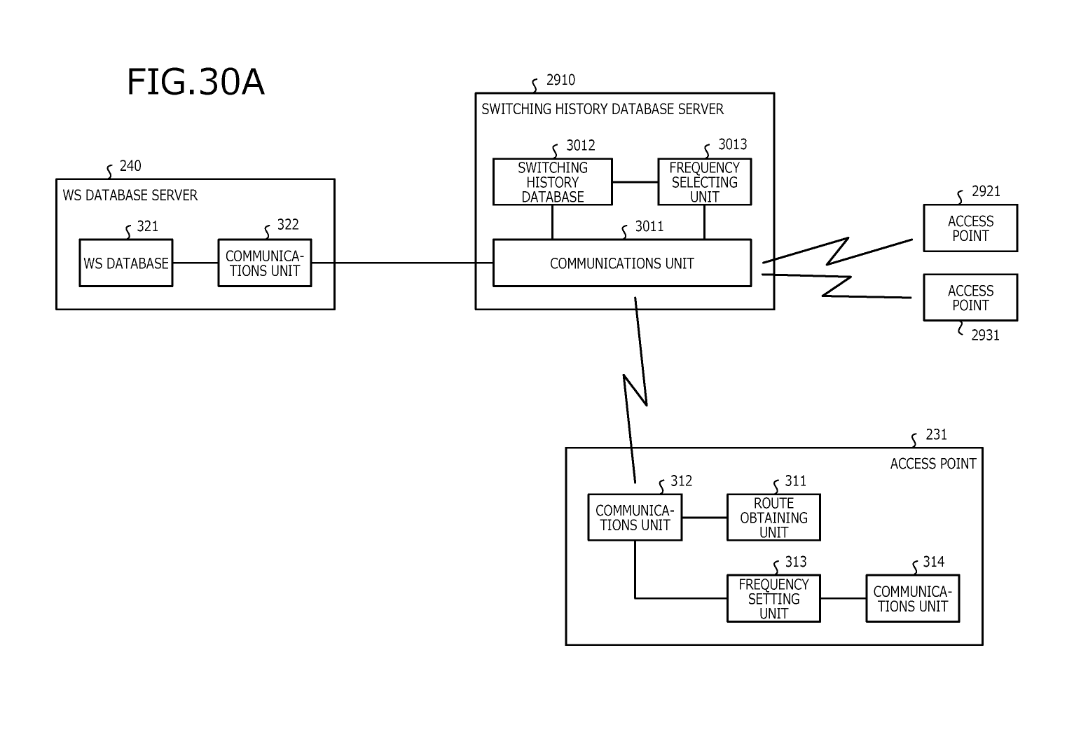

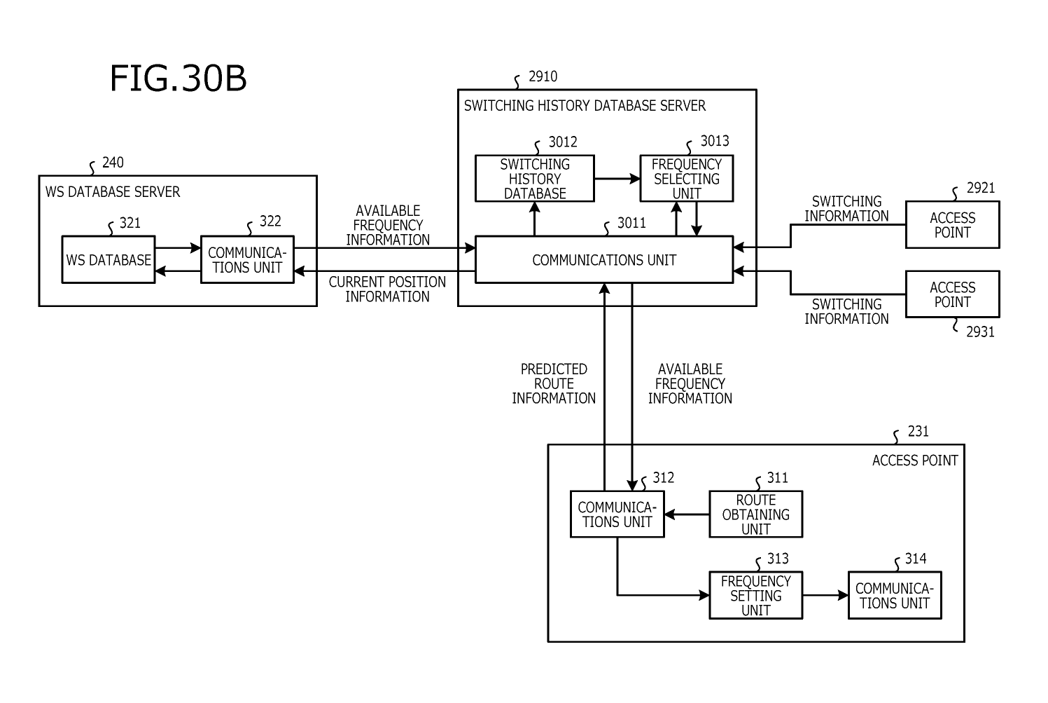

FIG. 30A is a diagram of an example of configuration of the communications system depicted in FIG. 29. FIG. 30B is a diagram of an example of signal flow in the configuration of the communications system depicted in FIG. 30A. In FIGS. 30A and 30B, parts identical to those depicted in FIGS. 3A and 3B are designated by the same reference letters or numerals used in FIGS. 3A and 3B and will not again be described.

As depicted in FIGS. 30A and 30B, the switching history database server 2910 includes a communications unit 3011, a switching history database 3012, and a frequency selecting unit 3013. The communications unit 3011 performs radio communication with access points 231, 2921, and 2931. For example, the communications unit 3011 receives switching information transmitted from the access points 2921 and 2931. The receiving unit 3011 then causes the switching history database 3012 to store the received switching information.

The communications unit 3011 receives predicted route information transmitted from the access point 231. The communications unit 3011 outputs the received predicted route information to the frequency selecting unit 3013. The communications unit 3011 transmits to the WS database server 240, current position information indicating the current position of the access point 231 indicated by the received predicted route information.

The communications unit 3011 receives available frequency information transmitted from the WS database server 240. The communications unit 3011 outputs the received available frequency information to the frequency selecting unit 3013. The communications unit 301 transmits to the access point 231, available frequency information output from the frequency selecting unit 3013.

The frequency selecting unit 3013 selects a frequency to be used by the access point 231, based on the predicted route information and the available frequency information output from the communications unit 3011 and based on the switching information stored in the switching history database 3012. The frequency selecting unit 3013 outputs available frequency information indicating the selected frequency to the communications unit 3011.

As depicted in FIGS. 30A and 30B, the WS database server 240 includes the WS database 321 and the communications unit 322. The communications unit 322 performs wire-based communication with the switching history database server 2910. For example, the communications unit 322 receives current position information transmitted from the switching history database server 2910. The receiving unit 322 specifies available frequencies of the access point 231, based on the current position of the access point 231 indicated by the received current position information and based on correspondence information stored in the WS database 321. The communications unit 322 transmits available frequency information indicating the specified available frequencies to the switching history database server 2910.

The receiving units 121 and 2821 and the transmitting unit 125 depicted in FIGS. 28A and 28B can be realized by the communications unit 3011, for example. The obtaining unit 122 depicted in FIGS. 28A and 28B can be realized by the WS database server 240, for example. The calculating unit 123 and the selecting unit 124 depicted in FIGS. 28A and 28B can be realized by the frequency selecting unit 3013, for example. The storage unit 2822 depicted in FIGS. 28A and 28B can be realized by the switching history database 3012.

The switching history database server 2910 can be realized by the information processing apparatus 340 depicted in FIG. 3D, for example. The communications unit 3011 can be realized by the wire-based communications interface 344 and the radio communications interface 345 depicted in FIG. 3D, for example. The switching history database 3012 can be realized by the memory 342 depicted in FIG. 3D, for example. The frequency selecting unit 3013 can be realized by the CPU 341 depicted in FIG. 3D, for example.

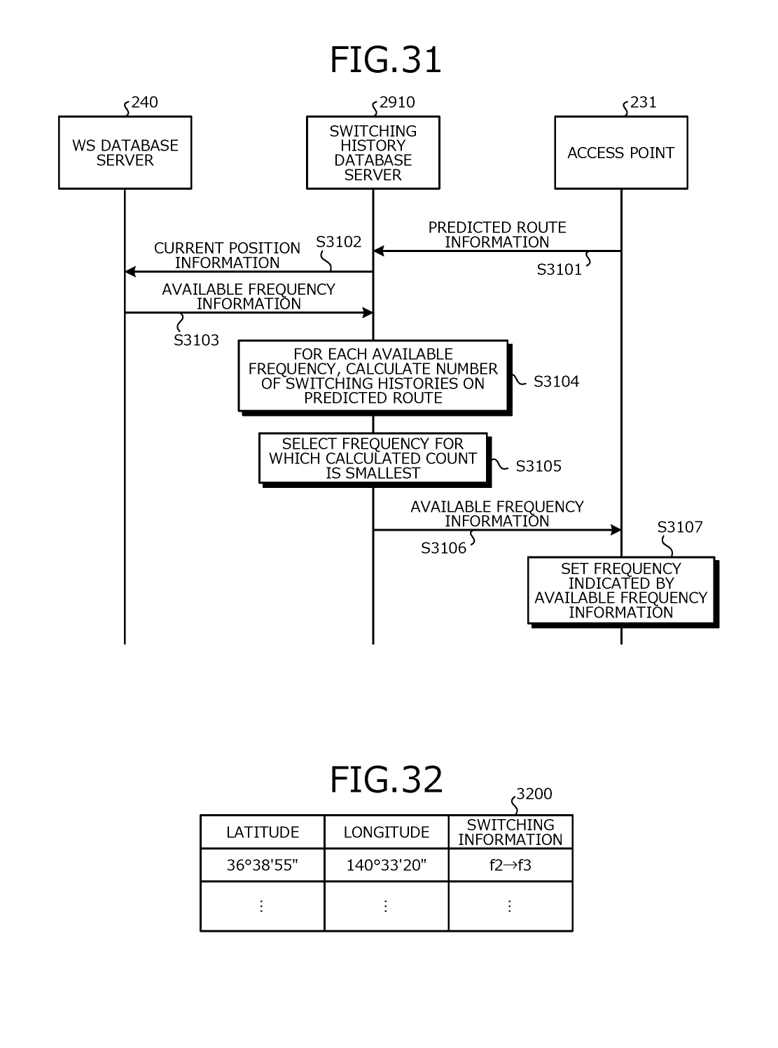

FIG. 31 is a sequence diagram of an operation example of the communications system depicted in FIG. 29. The communications system 200 depicted in FIG. 29 operates, for example, as indicated by the steps depicted in FIG. 31. First, the access point 231 transmits predicted route information indicating the current position and predicted route of the access point 231 to the switching history database server 2910 (step S2901). The switching history database server 2910 transmits to the WS database server 240, current position information indicating the current position of the access point 231 indicated in the predicted route information transmitted at step S3101 (step S3102).

The WS database server 240 transmits to the switching history database server 2910, available frequency information indicating available frequencies at the position indicated by the current position information transmitted at step S3102 (step S3103).

The switching history database server 2910 then calculates the number of switching histories on the predicted route indicated by the predicted route information, for each of the available frequencies indicated by the available frequency information transmitted at step S3103 (step S3104). The switching history database server 2910 then selects a frequency having a minimum number calculated at step S3104, among the available frequencies indicated by the available frequency information (step S3105).

The switching history database server 2910 transmits to the access point 231, available frequency information indicating the frequency selected at step S3105 (step S3106). The access point 231 sets the frequency indicated by the available frequency information transmitted at step S3106, as a frequency to be used for radio communication by the access point 231 (step S3107), and terminates a series of the operations.

The above operations enable the access point 231 to set a frequency for which the switching history count on the predicted route is fewer among frequencies available to the access point 231 at the current position of the access point 231. As a result, frequency switching by the access point 231 can be reduced.

The operations depicted in FIG. 31 are executed, for example, at the time of powering on of the access point 231. The timing at which the operations depicted in FIG. 31 are executed are not limited hereto. For example, the operations depicted in FIG. 31 may be executed every time the frequency being used by the access point 231 becomes unavailable as a result of movement of the access point 231. This can reduce frequency switching, not only at the time of powering on.

The operations depicted in FIG. 31 may be executed every time the predicted route L1 of the access point 231 changes. The operations depicted in FIG. 31 may be executed periodically. This enables the frequency switching by the access point 231 to be reduced, irrespective of a change in the predicted route L1 of the access point 231 due to rerouting, etc.

FIG. 32 is a diagram of an example of switching information. When frequency switching occurs, the access points 231, 2921, and 2931 transmit switching information 3200 depicted in FIG. 32, for example, to the switching history database server 2910. In the switching information 3200, switching information is correlated with the position where frequency switching has occurred. The switching information indicates the frequencies before and after the switching.

For example, a first record of the switching information 3200 indicates that the frequency has switched from frequency f2 to frequency f3 at latitude (36 [degrees], 38′55″) and longitude (140 [degrees], 33′20″).

In this manner, according to the fifth embodiment, the radio communications apparatus can set a frequency for which the occurrence of switching to another frequency on the predicted route is fewer among the frequencies available to the radio communications apparatus at the position of the radio communications apparatus. As a result, frequency switching by the radio communications apparatus can be reduced.

A sixth embodiment will be described about parts different from the above embodiments. In the above embodiments, although description has been given of a case where only a single network configured by WS devices such as the access point 231 is present, configuration may be such that mutual interference is taken into consideration, if plural networks are present.

For example, mutual interference can be prevented by managing the frequencies used by the WS devices belonging to respective networks in the WS database server 240 such that different frequencies are used between adjacent networks.

When receiving a predicted route from the access point 231 in motion, the WS database server 240 manages the frequencies used so as to suppress interference with the other WS devices on the route through which the access point 231 travels.

For example, frequency assignment to the access point 231 is performed in order of arrival. At the time of selecting the frequency to be used by the access point 231, the frequency usage status is also considered of WS devices located near the predicted route of the access point 231.

If the frequency selected by the methods described in the above embodiments has already been used by another WS apparatus located near the predicted route of the access point 231, the other WS apparatus may be caused to change its frequency.

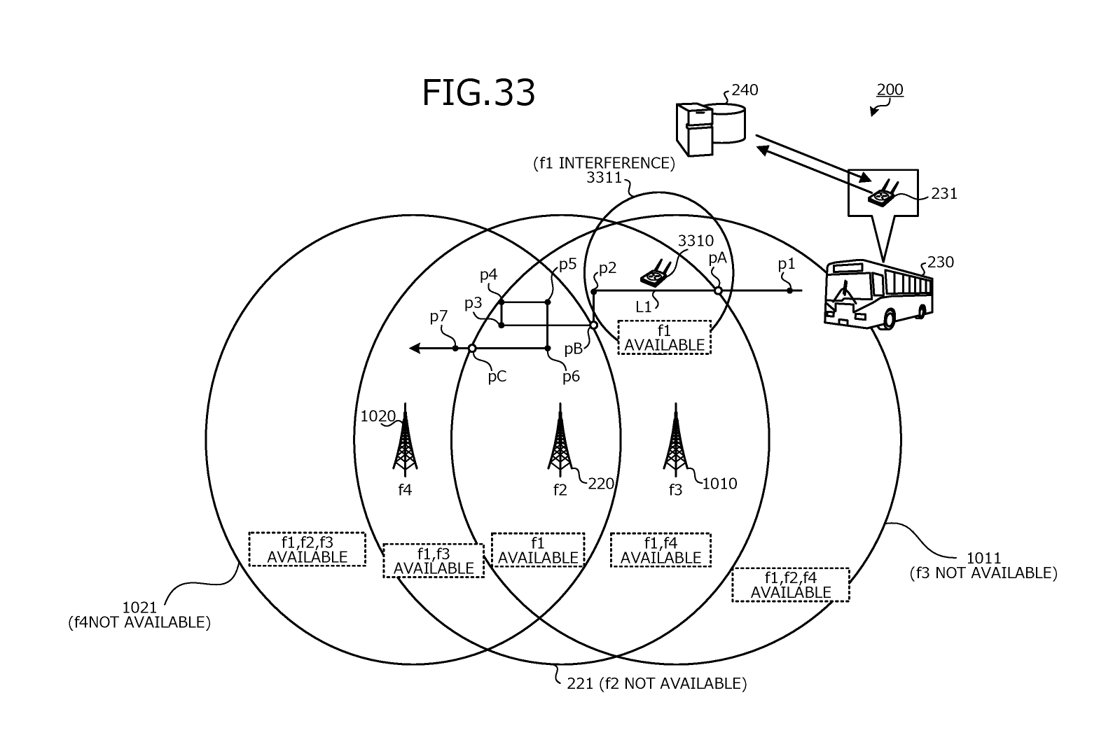

FIG. 33 is a diagram of an application example of the communications system according to the sixth embodiment. In FIG. 33, parts identical to those depicted in FIG. 10 are designated by the same reference letters or numerals used in FIG. 10 and will not again be described.

In the example depicted in FIG. 33, the passage point p2 is not in the area 1021 but is in the areas 221 and 1011. Thus, the frequencies f1 and f4, are available to the access point 231 at the passage point p2. The passage points p3 to p6 are in the areas 221, 1011, and 1021. Thus, the frequency f1 is available to the access point 231 at the passage points p3 to p6. The passage point p7 is not in the area 1011 but is in the areas 221 and 1021. Therefore, the frequencies f1 and f3 are available to the access point 231 at the passage point p.

Assume however that a WS device 3310 is located near the predicted route L1 of the access point 231 and that the WS device 3310 is performing radio communication using the frequency f1. An Area 3311 is an area in which interference occurs with radio communication performed by the WS device 3310 using the frequency f1. In this case, if the access point 231 uses the frequency f1 from the boundary point pA to the passage point p2, for example, interference occurs with the WS device 3310.

Since the access point 231 and the WS device 3310 are WS devices using frequencies secondarily and have no priority for assignment, unlike licensed systems such as television stations 220, 1010, and 1020. It is desirable, however, that the access point 231 and the WS device 3310 do not use the same frequency.

For instance, a table indicating available frequencies is updated also using frequencies selected by the access point 231 and the WS device 3310 so that frequencies of the access point 231 and the WS device 3310 can be selected using the updated table.

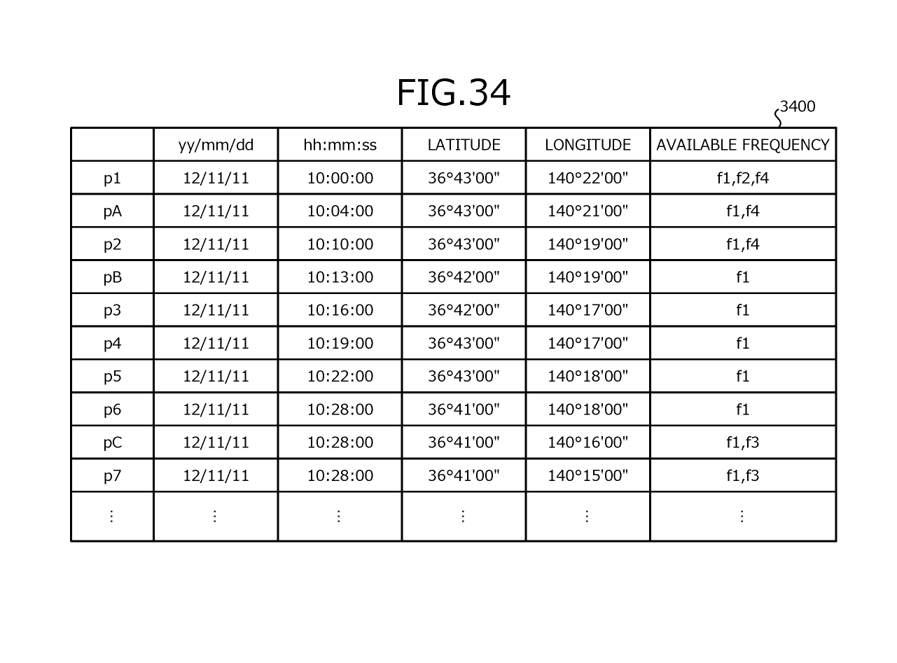

FIG. 34 is a diagram of an example of frequencies available at positions on the predicted route depicted in FIG. 33. The frequency selecting unit 323 of the WS database server 240 depicted in FIG. 33 creates, for example, a table 3400 depicted in FIG. 34 through calculations based on the predicted route information output from the communications unit 322 and based on the correspondence information stored in the WS database 321.

In the table 3400, similar to the table 700 depicted in FIG. 7, frequencies available to the access point 231 are correlated with each passage point of the access point 231 based on the predicted route indicated by the predicted route information.

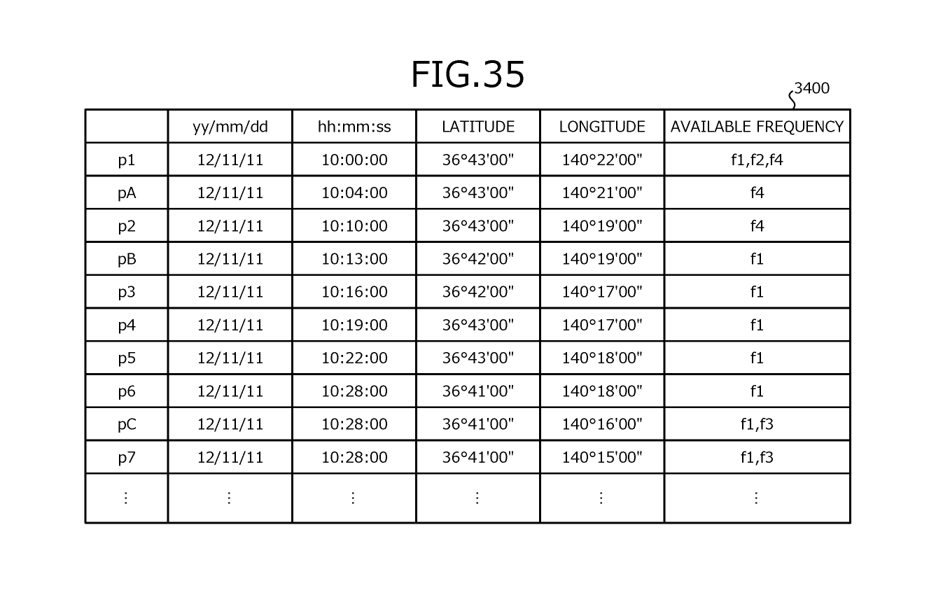

FIG. 35 is a diagram of an example of an updated table indicating available frequencies. If the WS device 3310 is using the frequency f1, the access point 231 cannot use the frequency f1 from the boundary point pA to the passage point p2. For this reason, the frequency f1 is excluded from frequencies corresponding to the boundary point pA and the passage point p2. Thus, in this case, the frequency selected from among the frequencies f1, f2, and f4 as a frequency to be used by the access point 231 is, for example, the frequency f4 for which switching does not occur until the boundary point pB.

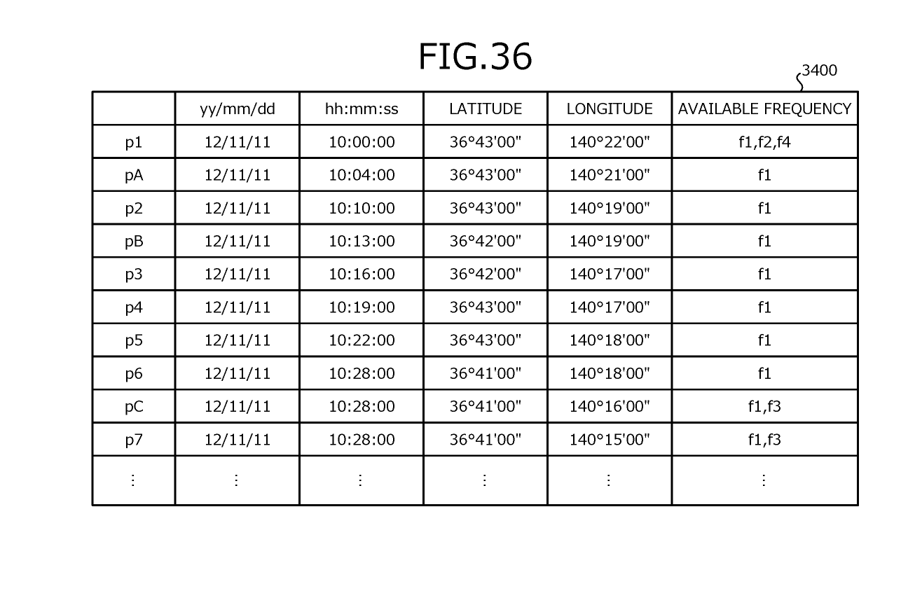

FIG. 36 is a diagram of another example of the updated table indicating available frequencies. For example, if the WS device 3310 switches the frequency from frequency f1 to frequency f4, the access point 231 cannot use the frequency f4 from the boundary point pA to the passage point p2. The access point 231 is allowed to use the frequency f1 from the boundary point pA to the passage point p2.

For this reason, in the table 3400, the frequency f4 is excluded from frequencies corresponding to the boundary point pA and the passage point p2. Thus, in this case, for example, the frequency f1 for which switching does not occur is selected as the frequency to be used by the access point 231 among the frequencies f1, f2, and f4.

As set forth hereinabove, according to the communications system, the communications control apparatus, the radio communications apparatus, and the communications method, frequency switching can be reduced. As a result, the volume of communication accompanying frequency switching, for example, can be reduced.

According to one aspect of the present invention, reduced frequency switching can be achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communications system including a radio communications apparatus and a communications control apparatus,
the radio communications apparatus comprising:
a transmitting unit that transmits to the communications control apparatus, position information indicating a position of the radio communications apparatus;
the communications control apparatus comprising:
a transmitting unit that transmits to the radio communications apparatus and based on correspondence information of positions of the radio communications apparatus and frequencies available to the radio communications apparatus, frequency information indicating the frequencies available to the radio communications apparatus at the position indicated by the position information transmitted from the radio communications apparatus;
the radio communications apparatus further comprising:
an obtaining unit that obtains history information indicating histories of switching of frequencies used for radio communication by the radio communications apparatus, in a predetermined range that includes the position of the radio communications apparatus;
a calculating unit that, for each frequency indicated by the frequency information transmitted from the communications control apparatus, calculates a value corresponding to a count of histories of switching from the frequency to another frequency in the predetermined range, based on the history information obtained by the obtaining unit;
a selecting unit that selects a frequency to be used by the radio communications apparatus among the frequencies available to the radio communications apparatus at the position indicated by the position information, based on the value calculated by the calculating unit; and
a communications unit that performs radio communication using the frequency selected by the selecting unit.

2. The communications system according to claim 1, wherein
the predetermined range is a range of a size corresponding to a travelling speed of the radio communications apparatus.

3. The communications system according to claim 1, wherein
the predetermined range is a range corresponding to a travelling direction of the radio communications apparatus.

4. The communications system according to claim 1, wherein
the calculating unit calculates a count value of histories of switching from the frequency to another frequency, weighted according to a distance from the radio communications apparatus to a position where a corresponding switching occurred, and
the selecting unit selects a frequency to be used by the radio communications apparatus, based on the value calculated by the calculating unit.

5. A radio communications apparatus comprising:
a first obtaining unit that obtains frequency information indicating frequencies available to the radio communications apparatus at a position of the radio communications apparatus;
a second obtaining unit that obtains history information indicating histories of switching of frequencies used for radio communication by the radio communications apparatus, in a predetermined range that includes the position of the radio communications apparatus;
a calculating unit that, for each frequency indicated by the frequency information obtained by the first obtaining unit, calculates a count of histories of switching from the frequency to another frequency in the predetermined range, the calculating unit calculating the count based on the history information obtained by the second obtaining unit;
a selecting unit that selects a frequency to be used by the radio communications apparatus among the frequencies available to the radio communications apparatus at the position of the radio communications apparatus, the selecting unit selecting the frequency to be used by the radio communications apparatus based on the count calculated by the calculating unit; and
a communications unit that performs radio communication using the frequency selected by the selecting unit.

6. A communications method of a communications system including a radio communications apparatus and a communications control apparatus, the communications method comprising:
transmitting to the communications control apparatus by the radio communications apparatus, position information indicating a position of the radio communications apparatus;
transmitting to the radio communications apparatus by the communications control apparatus and based on correspondence information of positions of the radio communications apparatus and frequencies available to the radio communications apparatus, frequency information indicating the frequencies available to the radio communications apparatus at the position indicated by the position information transmitted from the radio communications apparatus;
obtaining by the radio communications apparatus, history information indicating histories of switching of frequencies used for radio communication by the radio communications apparatus, in a predetermined range that includes the position of the radio communications apparatus;
calculating for each frequency indicated by the frequency information transmitted from the communications control apparatus, a count of histories of switching from the frequency to another frequency in the predetermined range, the calculating being performed by the radio communications apparatus based on the obtained history information;
selecting a frequency to be used by the radio communications apparatus among the frequencies available to the radio communications apparatus at the position indicated by the position information, the selecting being performed by the radio communications apparatus based on the calculated count; and
performing radio communication by the radio communications apparatus, using the selected frequency.
